(19) United States
(12) Patent Application Publication
(10) Pub. No.: US 2019/0327556 A1
(43) Pub. Date: Oct. 24, 2019

(54) COMPACT SOUND LOCATION MICROPHONE

(71) Applicant: STRETCH TECH LLC, Sarasota, FL (US)

(72) Inventors: John BEATY, New York, NY (US); Jamaal SAWYER, Astoria, NY (US)

(21) Appl. No.: 16/502,754

(22) Filed: Jul. 3, 2019

Related U.S. Application Data
(63) Continuation of application No. 15/346,270, filed on Nov. 8, 2016.
(60) Provisional application No. 62/330,964, filed on May 3, 2016.
(60) Provisional application No. 62/330,738, filed on May 2, 2016.
(60) Provisional application No. 62/253,065, filed on Nov. 9, 2015.

(51) Int. Cl. H04R 3/00; H04R 29/00; H04R 5/027

(52) U.S. Cl. CPC H04R 3/005; H04R 29/005; H04R 2201/403; H04R 2201/405; H04R 2430/20; H04R 5/027

(57) ABSTRACT

A system, method and program product for improved techniques for sound management and sound localization is provided. The present invention provides for improving sound localization and detection by inputting a predetermined location's dimensional data and location reference and processing detected sound details, detection device details and the associated location dimensional data as sound localization information for multi-dimensional display. The present invention provides mapping information of sound, people and structural information for use in multiple applications including residential, commercial and emergency situations.

### CROSS-REFERENCE TO RELATED APPLICATIONS

This application is a continuation application of U.S. patent application Ser. No. 15/346,270, filed on Nov. 8, 2016, which claims the benefit of U.S. Provisional Patent Application No. 62/253,065, filed on Nov. 9, 2015, entitled “COMPACT SOUND LOCATION MICROPHONE,” claims the benefit of U.S. Provisional Patent Application No. 62/330,738, filed on May 2, 2016, entitled “SPLIT COMPACT MICROPHONE ARRAY” and further claims the benefit of U.S. Provisional Patent Application No. 62/330,964, filed on May 3, 2016, entitled “COMPACT SPLIT MICROPHONE ARRAY,” all of which are incorporated herein by reference in its entirety.

This application is related to U.S. patent application Ser. No. 14/162,355 (Attorney Docket No. 5227C) filed on Jan. 23, 2014, entitled “SYSTEM AND METHOD FOR MAPPING AND DISPLAYING AUDIO SOURCE LOCATIONS,” and U.S. Pat. No. 8,704,070 (Attorney Docket No. 5227P), issued on Apr. 22, 2014, entitled “SYSTEM AND METHOD FOR MAPPING AND DISPLAYING AUDIO SOURCE LOCATIONS,” and U.S. Pat. No. 9,042,563 (Attorney Docket No. 5379P), issued on May 26, 2015, entitled “SYSTEM AND METHOD TO LOCALIZE SOUND AND PROVIDE REAL-TIME WORLD COORDINATES WITH COMMUNICATION,” all of which are incorporated herein by reference in their entireties.

### FIELD OF THE INVENTION

The present invention relates generally to the field of sound management and sound localization involving locating sound sources in one or more defined area. More particularly, the present invention relates to methods and arrangements for improved techniques for sound management and sound localization, and providing for the specifics of a predetermined location's physical layout, a listener's static or dynamic location, and also for differentiation as between electronically-generated sound and human sound (e.g., vocal emanations, talking, etc.).

### BACKGROUND

There are numerous implementations to using microphones in predefined areas to improve sound quality. For instance, residential entertainment systems employ a central microphone to listen for each speaker arranged in a room by a residential user when the entertainment system is first implemented; in such a system, the microphone listens for sounds from each speaker and a processor determines an approximate physical arrangement. From the determined arrangement, the entertainment system adjusts output characteristics for each speaker such that an optimized sound quality can be experienced by the user at a predetermined location, typically that of where the microphone is placed during testing. Other systems may employ an array of microphones (directional, omnidirectional, etc.) to achieve a similar result in a more complex setting.

While microphones may be designed and utilized in arrangements to approximate physical locations of speakers in a predetermined area, the precise location of each speaker is often difficult to obtain. Further, because a predetermined area is often more complex than a simple box arrangement, many factors and characteristics about the predetermined area are often not known or accounted for in the determination of speaker locations. For instance, few locations, such as rooms or arenas, have a specific or pure geometric configuration; often there are cut-outs, heating and ventilation encumbrances, and other structural inclusions that can impact the transmission of sound waves across and throughout the area. This typically may also result in human error of speaker placement or may result in a contractor's placing speakers in locations that may be more convenient for structural placement than for sound quality. Additionally, often these systems result in a single preferred point of sound quality which can be limiting to multi-users in larger venues, residential situations where the furniture layout is modified, and even situations where the listener moves within a room, for instance. Further, these systems typically account for sound waves associated with the electronic sound generated from the system.

Therefore it is desired to have an improved technique for sound localization that provides for the specifics of a predetermined location's physical layout, a listener's static or dynamic location, and also for differentiation as between electronically-generated sound and human sound (e.g., vocal emanations, talking, etc.). Further, it is desired to have such an improved technique that additionally provides for identifying one or more person's presence in a predetermined area using voice recognition technology. The present invention addresses such needs.

### SUMMARY

The present invention fulfills these needs and has been developed in response to the present state of the art, and in particular, in response to the problems and needs in the art that have not yet been fully solved by currently available technologies.

One embodiment of the present invention provides for A method for improving sound localization and detection, comprising: inputting a predetermined location's dimensional data and location reference data for one or more detection devices in the predetermined location; identifying a sound detected by the one or more detection devices; and, providing sound localization information to one or more receiving sources; wherein sound localization information includes position and location information in relation to the one or more detection devices and the detected sound in association with the predetermined location's dimensional data.

Another embodiment of the present invention provides for A computer program product stored on a computer usable medium, comprising: a computer readable program means for causing a computer to control an execution of an application to perform a method for improving sound localization and detection including: inputting a predetermined location's dimensional data and location reference data for one or more detection devices in the predetermined location; identifying one or more sounds detected by the one or more detection devices; and, providing sound localization information to one or more users;

A further embodiment provides for a system for improving sound localization: comprising one or more detection devices arranged in a predetermined location directly associated with a physical dimensional representation of the location, one or more processors for processing detecting one or more sounds in the predetermined location in relation to reference sound characteristics and for mapping the detected one or more sounds in relation to the predetermined location's dimensional data for display; one or more detection devices in communication with the one or more processors; an analyzer that correlates a time difference of arrival of a detected sound and a reflected sound; and a communication interface for providing sound localization information for display.

In yet another embodiment, the present invention is a method for defining a reference sound position and producing an indicia proximate thereto in relation to one or more sound characteristics at a predetermined location. The method preferably includes: defining at least one sound characteristic to be detected; detecting at least one target sound in relation to the at least one sound characteristic; and determining the referenced sound position in relation to the detected target sound. Further the method provides for producing the indicia proximate to the determined referenced sound position.

In a further embodiment, the present invention is a method for determining a reference sound source location and performing an indicia proximate to the reference sound location, in relation to one or more targeted characteristics of one or more sound sources in a predetermined sound environment. The method includes defining one or more target sound characteristics being one or more of frequency range, decibel level, pitch range, loudness range, directional location, and period of time; defining one or more characteristics of the indicia as being one or more of visible, audible, and/or tactile; detecting at least one target sound in relation to the one or more target sound characteristics in the sound environment; and, determining the referenced sound source location in relation to the detected target sound. Preferably the method also includes assigning the indicia to be performed proximate to the determined referenced sound source location.

In a further embodiment, the present invention is a system for determining a reference sound source location and displaying one or more images proximate to the reference sound location, in relation to one or more predetermined performance characteristics for a sound environment. Preferably, included in the system is a sound detection device for detecting one or more sounds in the sound environment in relation to one or more predetermined performance characteristics; a processor for processing detected sound information in relation to reference sound source location of the sound environment and generating one or more images for display proximate to the reference sound source location; and an image display device for displaying the generated one or more images proximate to the reference sound source location.

As used herein, the term microphone is intended to include one or more microphones which may include an array.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 sets forth a diagrammatic example of the average polar responses of a violin and a cello at a varying range of frequencies;

FIG. 2 sets forth a diagrammatic representation of sound sources and locations where listening or detection of the sounds from the sound sources may occur, from a perspective of an audience viewer;

FIG. 3 sets forth a diagrammatic representation of sound sources, locations where listening or detection of the sounds from the sound sources may occur, and a probable center line of where an aggregate sound source;

FIG. 4 sets forth an environmental arrangement having multiple sound sources with a listener at a particular location in relation to the multiple sound sources near the front of a stage;

FIG. 5 sets forth an environmental arrangement having multiple sound sources with a listener at a particular location in relation to the multiple sound sources towards the side rear of a stage;

FIG. 6 sets forth a flowchart of the present invention in accordance with one or more embodiments;

FIG. 7 sets forth a flowchart of the present invention in accordance with one or more embodiments having a dependence on one or more predetermined times;

FIG. 8 sets forth a flowchart of the present invention in accordance with one or more embodiments where the definition of characteristic data also includes a dependence on one or more predetermined times;

FIG. 9 sets forth an example of an interactive image effect for an indicia of the present invention;

FIG. 10 depicts an example of an interactive image effect for an indicia of the present invention in accordance with one or more embodiments of the present invention;

FIG. 11 depicts an example of multi-viewing interactive images for a plurality of indicia using the present invention in accordance with one or more embodiments;

FIG. 12 illustrates a data processing system suitable for storing the computer program product and/or executing program code in accordance with one or more embodiments of the present invention;

FIG. 13 illustrates an apparatus arrangement of the present invention including a data processing system suitable for storing the computer program product and/or executing program code in accordance with one or more embodiments of the present invention;

FIG. 14 sets forth a flowchart of the present invention in accordance with one or more embodiments where the definition of characteristic data also includes a dependence on one or more predetermined times using an input device of an acoustic camera and an output device of an image projection system;

FIG. 15 illustrates an environment in which the present invention is in operation;

FIG. 16 illustrates an environment 1600 in which the present invention is in operation using sound animation in real-time;

FIG. 17 illustrates an environment in which the present invention is in operation and projecting holographic animated imagery with live performers at a concert event

FIG. 18 presents a typical arrangement of a predetermined area, such as a room in a residence.

FIG. 19 sets forth a flowchart for the operation of a system and method in accordance with the present invention in accordance with one or more embodiments.

FIG. 20 illustrates a data processing system suitable for storing the computer program product and/or executing program code in accordance with one or more embodiments of the present invention;

FIG. 21A illustrates another embodiment of a data processing system suitable for storing the computer program product and/or executing program code in accordance with one or more embodiments of the present invention;

FIG. 21B illustrates yet another embodiment of a data processing system suitable for storing the computer program product and/or executing program code in accordance with one or more embodiments of the present invention;

FIG. 21C illustrates still another embodiment of a data processing system suitable for storing the computer program product and/or executing program code in accordance with one or more embodiments of the present invention;

FIG. 22 sets forth a flowchart for the operation of another embodiment of a system and method in accordance with the present invention in accordance with one or more embodiments; and

FIG. 23 sets forth a flowchart for the operation of yet another embodiment of a system and method in accordance with the present invention in accordance with one or more embodiments.

### DETAILED DESCRIPTION OF PREFERRED EMBODIMENTS

The present invention relates generally to the methods and arrangements for improved techniques for sound localization that provides for the specifics of a predetermined location's physical layout, a listener's static or dynamic location, and also for differentiation as between electronically-generated sound and human sound. The determination and processing, as used herein, may include the use and application of voice recognition technology and software. The present invention further provides for identifying one or more person's presence in a predetermined area using voice recognition technology.

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the claimed invention is not intended to be limited to the embodiment shown but is to be accorded the widest scope consistent with the principles and features described herein.

Further aspects of the claimed invention include a compact array of 4 microphones placed one over three, spaced inches apart. Such an arrangement is design to fit on a television, computer screen, or embedded in a third party display, although other arrangements are possible. Additional embodiments include a compact array of multiple microphones (e.g., six microphones) split into groups (e.g., two of three microphones) spaced apart (e.g., within inches of each other). As described in further detail below, embodiments of the claimed invention programmatically incorporate dimensions of a screen, the arrays relation to the screen, and using such dimensions to effect animations appearing on the screen, such as turn the faces of CGI characters on screen to look out into a room at the people speaking to the device.

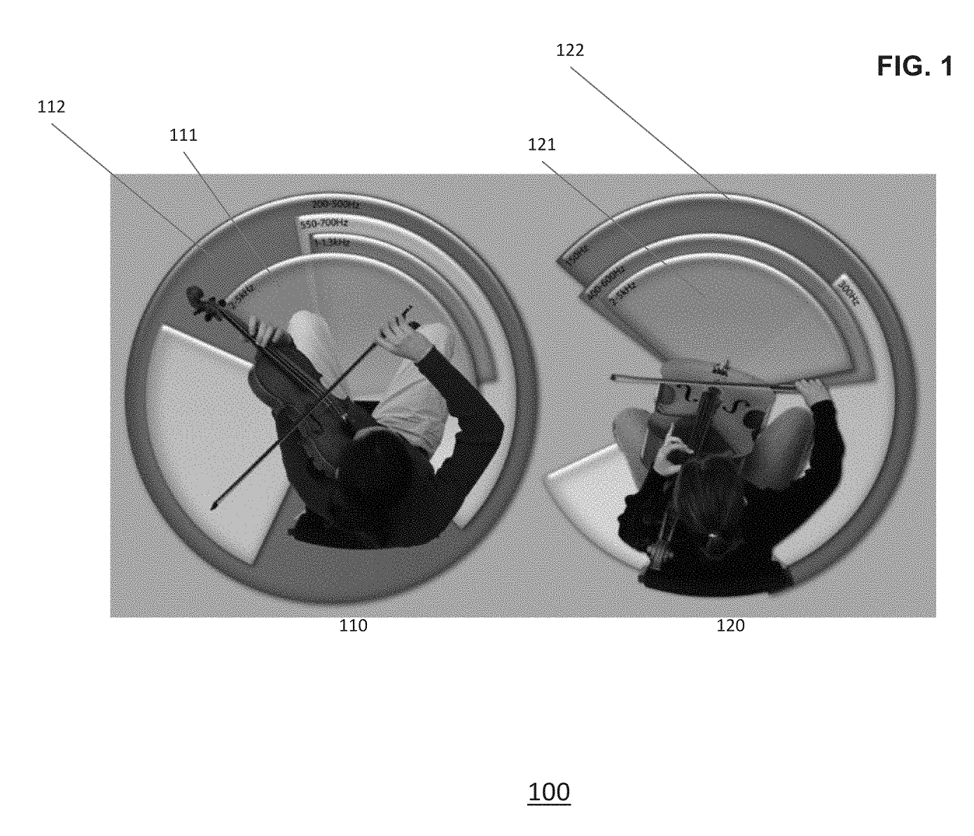

Turning now to the figures, FIG. 1 sets forth a diagrammatic example 100 of the average polar responses of the violin 110 and the cello 120 at a varying range of frequencies. From FIG. 1, the violin 110 and the cello 120 have similar sound dispersions in the 2-5 kHz range (111, 121), where both generally emanate around a local position of the string and bridge. However, the violin and the cello vary considerable in the sound dispersion in the range of 200-500 Hz, where the violin circumferentially radiates around its local position (112) and the cello radiates only partially (122). As a result, it remains a challenge to determine a specific location or position of a sound source.

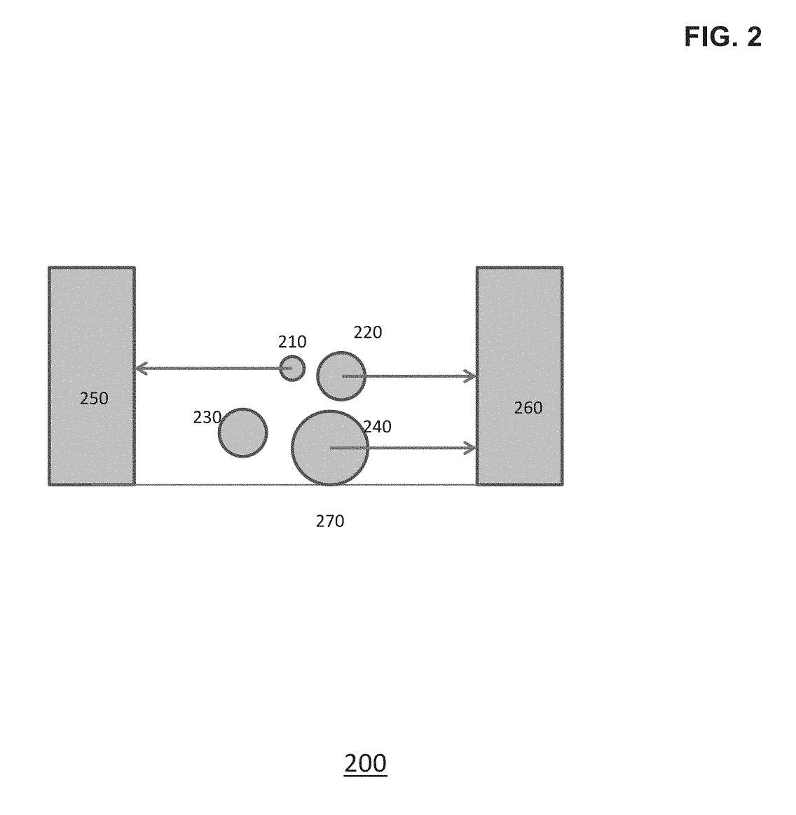

FIG. 2 sets forth a diagrammatic representation 200 of sound sources (210, 220, 230, 240) and locations where listening or detection of the sounds from the sound sources may occur (250, 260), from a perspective of an audience viewer. For example, sound sources (210, 220, 230, 240) may represent a live band at a concert and the viewer of FIG. 2 is in the audience. It is understood that sound travels, when unobstructed, at a rate equivalent to the speed of the sound. It is also recognized that detection locations (250, 260) may be determined to be at a predetermined distance from a sound source. Using a standard relationship of rate X time=distance, calibration techniques may be used to determine whether sound traveling from a sound source is obstructed and whether the equipment being used for detection is located accurately.

From FIG. 2, microphones or other detection equipment may be placed at 250, 260 to detect sounds emanating from the stage area 270. Sound sources 230 and 240 are not equidistant from the detectors 250 and 260, from the Figure. Sound source 230 is located at a first predetermined distance from detector 260 and sound source 240 is located at a second predetermined distance from detector 260. Sound emanating from 230 will reach the detector 260 before sound emanating from sound source 240. However, sound emanating from 230 will reach the detector 250 after sound emanating from sound source 240. While the distance of each of the sound sources from a referenced detector can be determined using calculations associated with the standard relationship, determining with accuracy and specificity a sound source's position remains a challenge due to sound dispersion, sound source movement, and the placement of the detection equipment.

Another characteristic of sound is related to its loudness where loud sounds result from a larger pressure variation which dissipates over distance. As each sound may travel across a room at the speed of sounds, the pressure variation produced by each sound may be affected by competing sounds, time, and the distance the sound travels. In such a setting, determining a particular center point for an aggregated set of sound sources or for a single sound source surrounded by competing sound sources, presents a challenge.

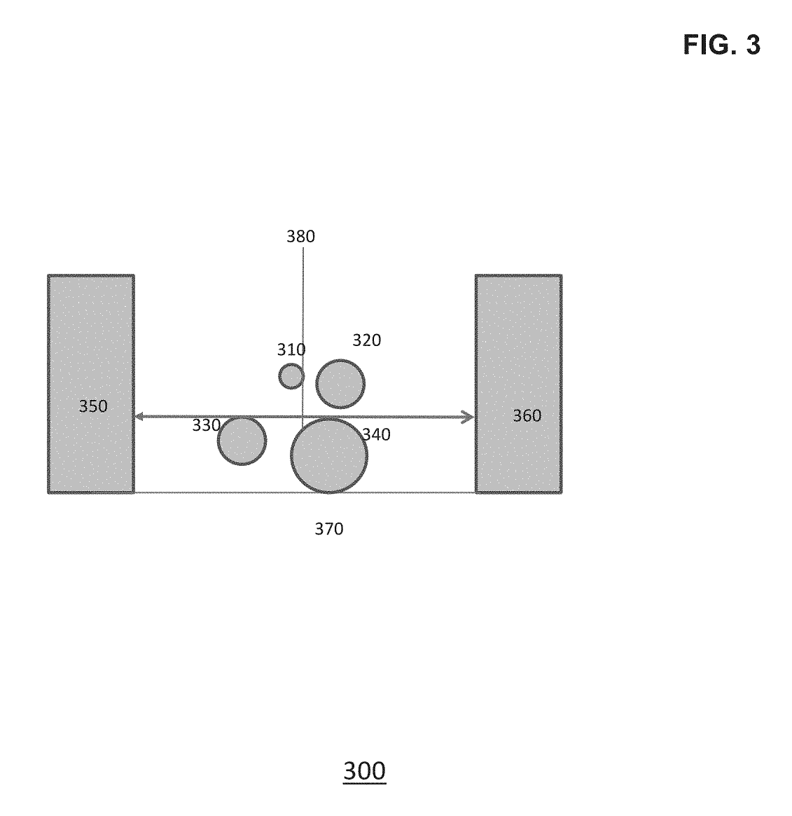

For instance, FIG. 3 sets forth a diagrammatic representation 300 of sound sources (310, 320, 330, 340), locations where listening or detection of the sounds from the sound sources may occur (350, 360), and a probable center line of where an aggregate sound source. From FIG. 3, each sound source (310, 320, 330, 340) may produce sounds that are of frequencies which overlap varyingly during a performance or presentation. In certain situations, one or more of the sound sources may be a speaker, for instance. A listener may attempt to discern where a particular set of frequencies is emanating from by deploying one or more detection arrays (350, 360). However, while the distance of each of the sound sources from a referenced detector can be determined using calculations associated with the standard relationship, determining with accuracy and specificity an aggregate center for specific frequency targets or ranges in relation to multiple sound sources is a challenge due to competing sounds, sound dispersion, sound source movement, placement of the detection equipment, and other characteristics. Accordingly, determining where an aggregate center occurs, such as is estimated at 380, is difficult.

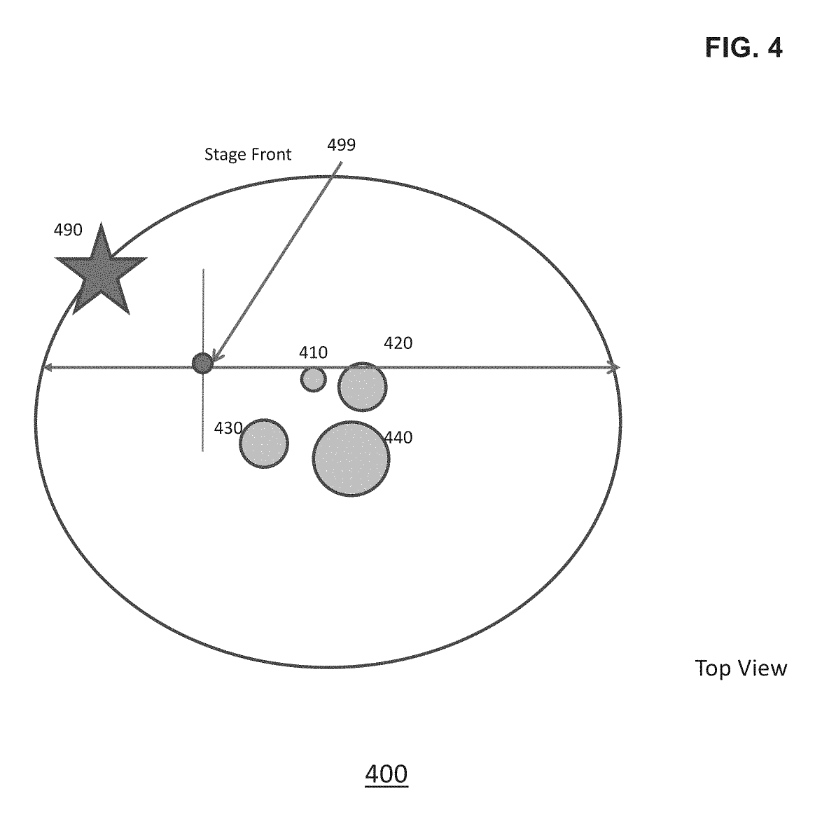

Further, FIG. 4 sets forth an environmental arrangement having multiple sound sources 400 with a listener 490 at a particular location in relation to the multiple sound sources near the front of a stage. From FIG. 4, being an overhead perspective, it may be a desired by the performance event to have the listener 490 focus on specific aspects of the performance at particular times or for particular periods. Unfortunately, using calculations associated with the standard relationship, the listener 490 may likely determine a perceived center point of the aggregated sound sources to be at 499. As a result, the focus of the listener 490 will generally be towards that perceived center point and may not focus towards specific highlights or performance effects that are associated with the sound sources and their specific characteristics. Unfortunately, the listener may not fully engage with the performance for a level of enjoyment as originally intended.

Similarly, an event producer may desire to align a visual feature, for a listener's enjoyment, with specific characteristics related to the sound, sound source and environment of the performance, where accuracy of determining an aligned association between a sound source location and timing information of sounds being or to be emanated from one or more sound sources is required.

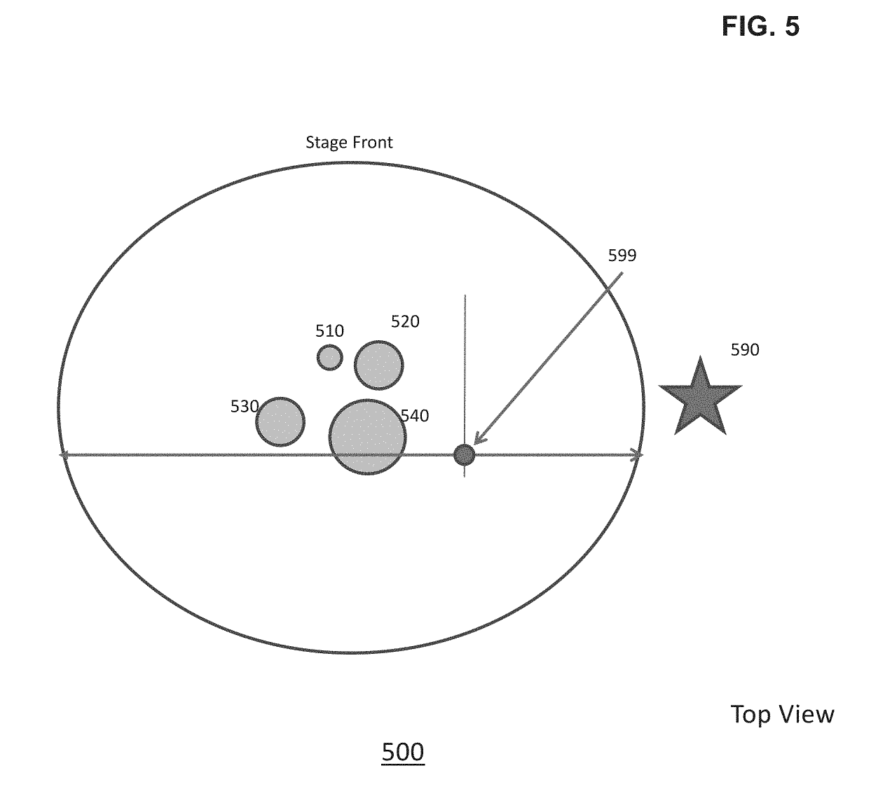

FIG. 5 sets forth an environmental arrangement having multiple sound sources 500 with a listener 590 at a particular location in relation to the multiple sound sources towards the side rear of a stage. From FIG. 5, the listener will likely have a perceived sound source aggregate center originating at 599 at a particular point in time, using calculations associated with the standard relationship, As a result, the focus of the listener 590 will generally be towards that perceived center point 599 and may not focus towards specific highlights or performance effects that are associated with the sound sources and their specific characteristics, particularly those towards the front of the stage. Unfortunately, the listener may not fully engage with the performance for a level of enjoyment as originally intended because of the listener's perceived sound source center point.

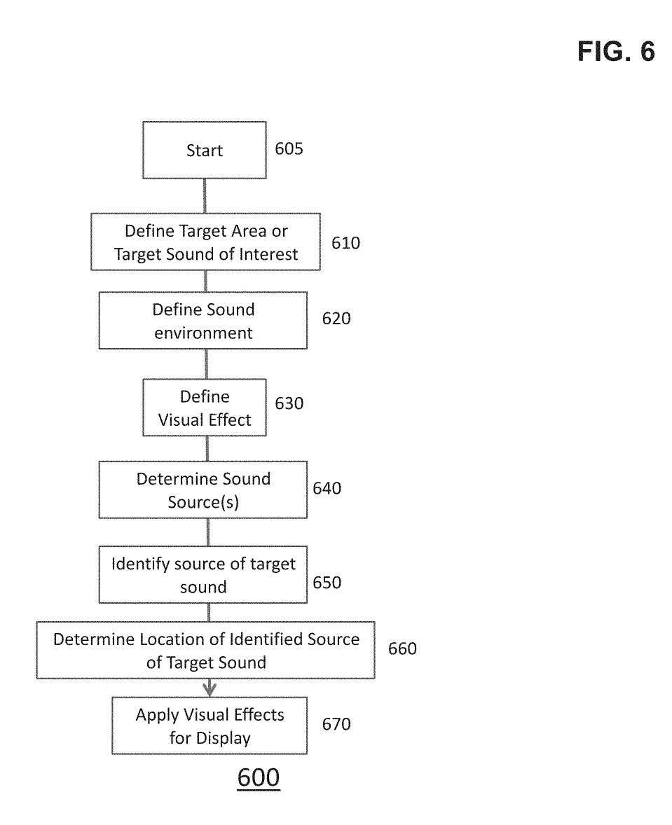

FIG. 6 sets forth a flowchart 600 of the present invention in accordance with one or more embodiments. From FIG. 6, the process 600 begins at 605. At 610, a sound source is identified as being a target of interest for the process. For instance, in one embodiment, a user may identify one or more sound target characteristics for targeting. Sound target characteristics, by example, may include frequency range, decibel level, pitch range, loudness range, directional location, and period of time. The defined one or more sound target characteristics are received as input by the process for determination and identification of sound sources in a defined environment. It will be appreciated that in the absence of sound target characteristics, a default set of sound target characteristics may be utilized with the present invention.

Further from FIG. 6, the sound environment is defined at 620. A sound environment may be, for instance, a music hall, soundstage, venue, outdoors, indoors, etc., whereby it is intended to define a location where sources of sound to be detected shall be anticipated to emanate from.

At 630, an effect is identified for use by the present invention. As used herein, the term indicia is intended to be far reaching where an indicia may be visual, audible or tactile in manner. For instance, an indicia may include but not be limited to a visual effect, audible effect, tactile effect, visual image, cartoon, character representation, video, anime, hologram, light beam, projecting fire, animation, and combinations thereof, for display in relation to a detected target sound or determined reference sound location.

Further an indicia may one or more images for instance where each image or motion image is displayed at a particular predetermined time or in response to a particular predetermined sound characteristics, or both. For example, in one embodiment, a visual indicia is one or more of a holographic image displayed in relation to a determined reference sound position at intervals defined by one or more predetermined times. By further exemplar, where the environment a stage of a band, the indicia may be a hologram or a holographic image of a person, anime, icon, etc., which may have movement associated with the imagery or may have movement in response to sounds detected by the present invention.

Further from FIG. 6, at 640, using the sound target characteristics defining the sound and the defined sound sources to be targeted, sound sources are identified within the environment using sensing apparatus of the present invention. Sound sensing apparatus may include any sound sensing device or means, including human, in which the sound may be determined to be present. In general, sensors capable of detecting air pressure changes may act as devices suitable with the present invention. Other examples may include microphones, audio capture devices, air pressure sensors, soundwave detectors, acoustic cameras, electronic control logic, sound sensor, listening devices, decibel triggers, speakers, and hydrophones, etc.

At 650, positional locations of the identified sound sources are determined using output of the sound sensing devices as input to a first location processor of the present invention. In one or more preferred embodiments, an array of microphones set at a fixed distance from a target reference point are utilized as sound sensing apparatus. Output from the microphone array is provided as input to the first location processor. The first location processor receives the array information and determines a first location of the targeted sound source, at a first instance in time.

For instance, in a further preferred embodiment, a microphone array of 30 microphones are set along a common x-axis reference plane in relation to the sound source's target reference frame. When the sound source transmits the sound to be sensed by the present invention, the sound is received non-uniformly by the microphone array. Since each microphone of the array is at a fixed distance in relation to one another and to the sound source target reference frame, the present invention can calculate a location position of the sound source target, at the time, t1, of the sound transmission. The first location processor of the present invention then determines a first location in relation to the target reference frame at t1.

A further embodiment includes the use of multiple microphone arrays where each array may vary in the number of microphones a part of the defined array and the location of each array in relation to the target reference frame may also differ. For this embodiment, when the sound source transmits the sound to be sensed by the present invention, the sound is received non-uniformly by the plurality of microphone arrays. Since each microphone of each array is at a fixed distance in relation to one another, to each array, and to the sound source target reference frame, the present invention can calculate a location position of the sound source target, at the time, t1, of the sound transmission.

In a further embodiment, the arrays are positioned multi-dimensionally around the target sound source. The first location processor of the present invention then determines a first location in relation to the target reference frame at t1.

It will be appreciated that in each of the referenced embodiments above, the positional location of the targeted sound source can be identified with particular accuracy.

Continuing from FIG. 6, at 660, output from the first location processor is provided as input to a first referential processor which associates the location information of the targeted sound source at t1 with the target reference axis, thereby determining the location of the identified source of target sound. The location of the identified sound source may also be used a reference location in the defined environment where the indicia of the present invention may be mapped to for positioning in relation to display, sound, appearance, etc. At 670, the visual effects (i.e., indicia) may be mapped and displayed in relation and proximity to the reference sound source.

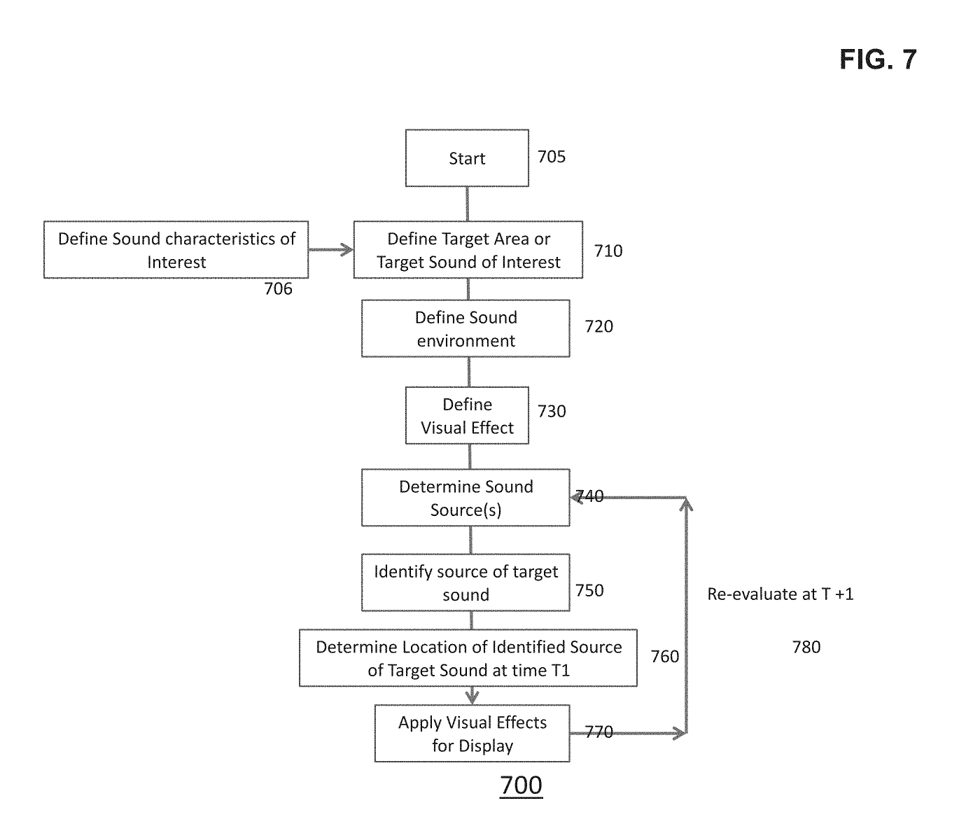

FIG. 7 sets forth a flowchart 700 of the present invention in accordance with one or more embodiments having a dependence on one or more predetermined times. From FIG. 7, the process 700 begins at 705 for an initial time t1. At 706, sound characteristics are identified and used further define the sound source or target area for the process at 710. The sound environment is defined at 720 and at 730, an indicia effect is identified for use by the present invention. At 740, using the sound target characteristics defining the sound and the defined sound sources to be targeted, sound sources are identified within the environment using sensing apparatus of the present invention. At 750, positional locations of the identified sound sources are determined using output of the sound sensing devices as input to a first location processor of the present invention. In one or more preferred embodiments, the location may be a two axis coordinate or a three-dimensional coordinate. At 760, the location of the identified source of target sound is determined. At 770, the visual effects (i.e., indicia) may be mapped and displayed in relation and proximity to the reference sound source.

At 780, the process re-evaluates the determined sound source using the predefined characteristics in accordance with steps 740-770 for time periods following the initial time period of t1. Accordingly, for t1+1, at 740, using the sound target characteristics defining the sound and the defined sound sources to be targeted, sound sources are identified within the environment using sensing apparatus of the present invention for the next time period. The process continues until 770 where the visual effects may be mapped and displayed in relation and proximity to the reference sound source based on determined and identified sound information and indicia for time t1+1. Accordingly, the process may repeat for additional time periods.

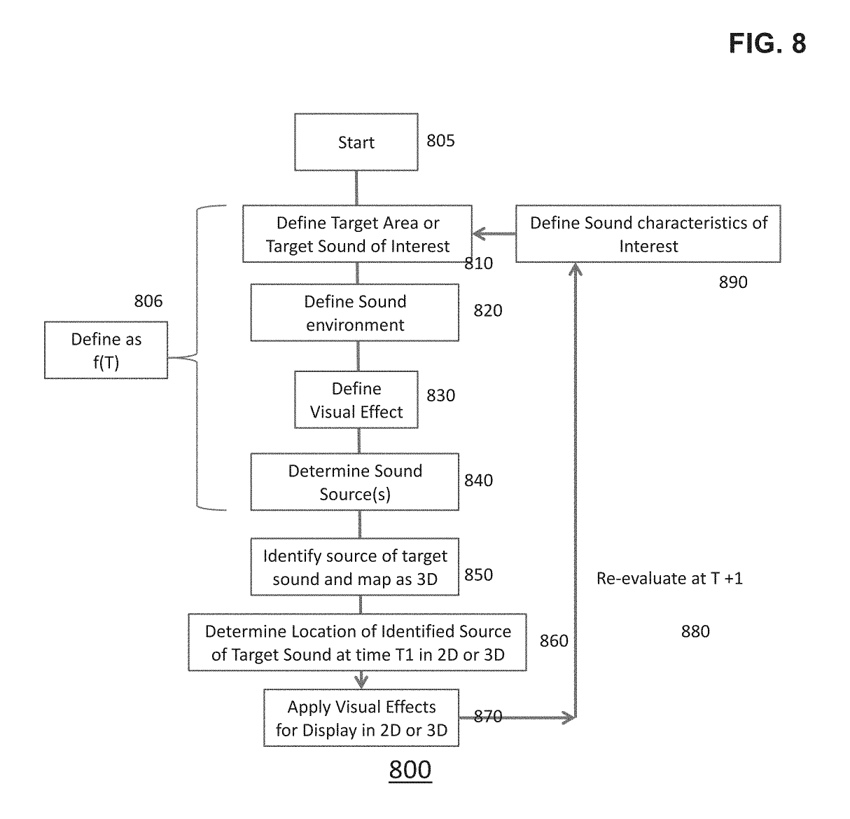

FIG. 8 sets forth a flowchart 800 of the present invention in accordance with one or more embodiments where the definition of characteristic data also includes a dependence on one or more predetermined times. From FIG. 8, the process 800 begins at 805 for an initial time t1. At 806, reference of the characteristic identification association as a function is time is set forth. From the process, the sound source or target area for the process is defined at 810. The sound environment is defined at 820 and at 830, an indicia effect is identified for use by the present invention as a function of time. At 840, using the sound target characteristics, each being function of time, defining the sound and the defined sound sources to be targeted, sound sources are identified within the environment using sensing apparatus of the present invention. At 850, positional locations of the identified sound sources are determined. In one or more preferred embodiments, the location may be a two axis coordinate or a three-dimensional coordinate. At 860, the location of the identified source of target sound is determined. The process continues until 870 where the visual effects may be mapped and displayed in relation and proximity to the reference sound source based on determined and identified sound information and indicia. Accordingly, the process may repeat 880 for t1+1 (for additional time periods). At 880, since the characteristics are a function of time, new definitions may be set forth at 890 and the process will continue with newly defined characteristics for the following process at a next interval of time.

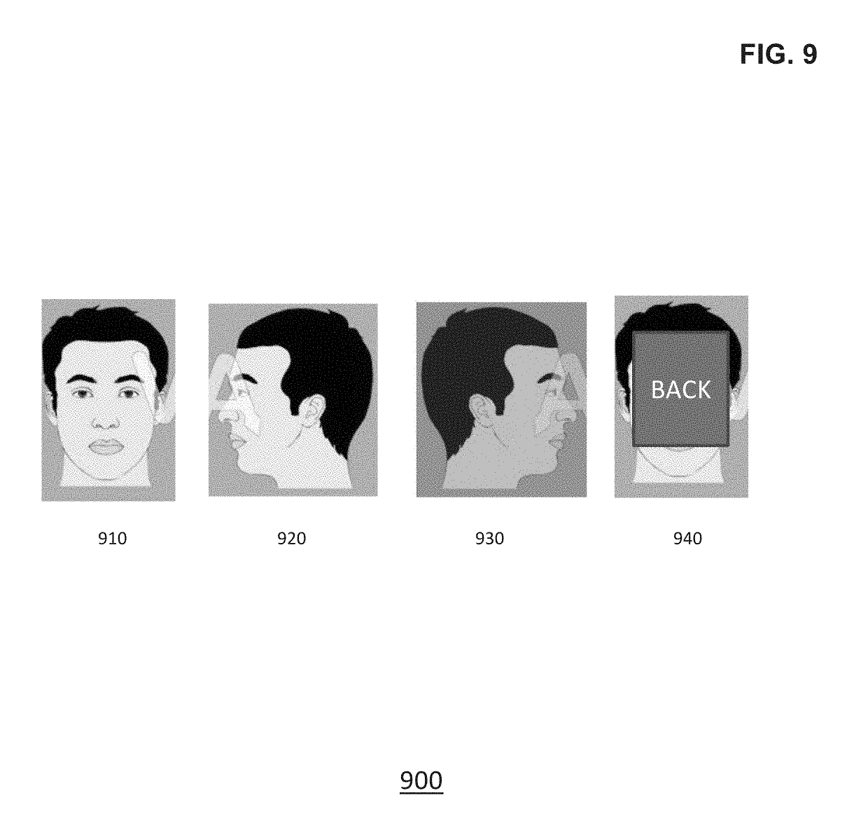

FIG. 9 sets forth an example of an interactive image effect for an indicia of the present invention. From FIG. 9, the character indicia presented is includes having one or more anthropomorphistic characteristics. 910 depicts a face facing forward. 920 depicts a face facing to the left. 930 depicts a face facing to the right. 940 depicts a face facing backward. Such facial profiles may be projected onto a film or other display in a sound environment in proximity to the reference sound location by the present invention.

Interactively, the present invention is further able to provide for having a facial indicia of 910 having limited or no action until the detection of a particular sound or suite of sounds in relation to one or more sound characteristics. Upon detection of such target sounds using the present invention, the indicia of 910 may change by image or motion in the display such that the face may turn towards the reference sound location. For example, if a sound were detected to the left of the front facing indicia of 910, the face may then morph so as to continue to appear to “look” towards the reference sound location. In so doing, the 910 forward face transitions to the 930 face looking right (or the face's left) and toward the detected sound source. The face indicia 930 would continue until a future time interval or until a period in which the detected sound ceases. If the detected sound were to cease, the face indicia 930 may be caused to return to the 910 forward facing look.

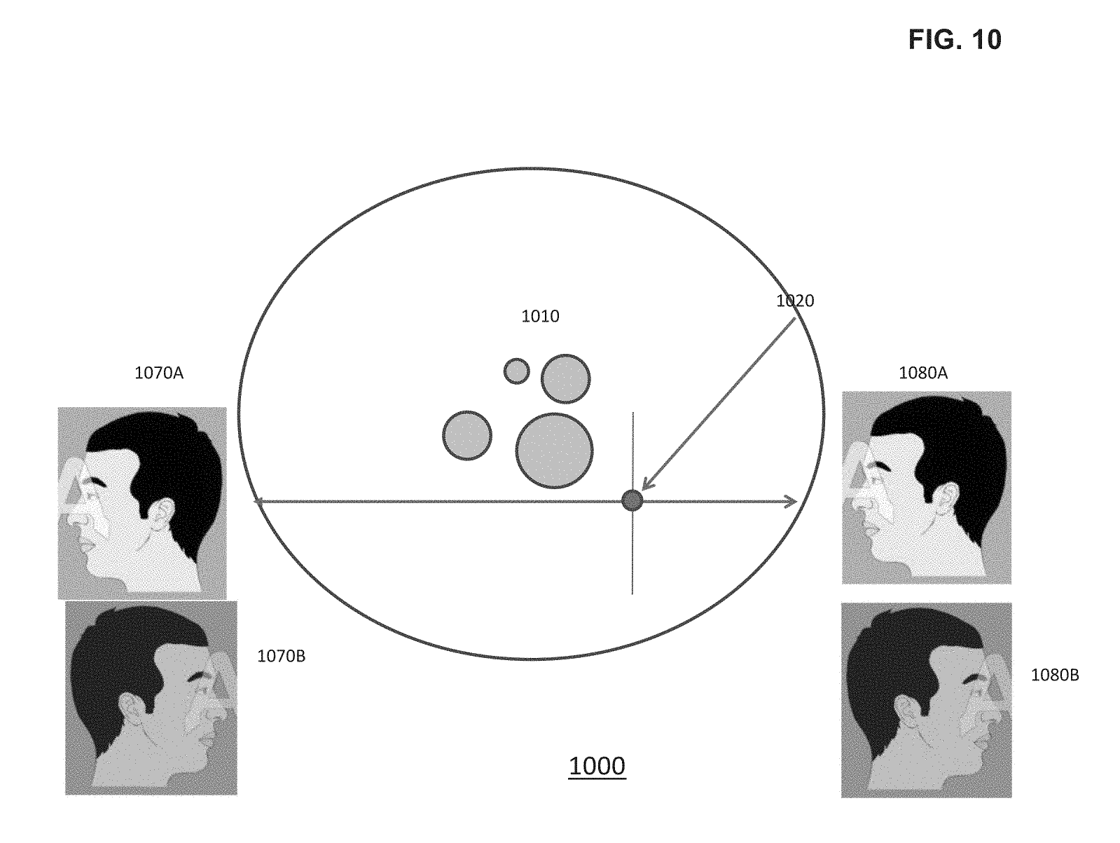

FIG. 10 depicts an example of an interactive image effect for an indicia of the present invention in accordance with one or more embodiments of the present invention. From FIG. 10, sound can emanate in the environment of 1000 from sound sources 1010. Determining a first reference sound location in relation to the sound sources has been performed by the present invention, determining such reference location to be at 1020. In the example of the present invention, the facial indicia 1070 and 1080 include defined characteristics that also include movement to occur upon the detection of certain sound sources having predetermined sound characteristics.

From FIG. 10 and operatively, using the present invention, facial indicia 1070A is normally facing away from the sound source until a particular sound source is detected. Upon detection of the particular sound source, the away facing facial indicia 1070A transitions to the facing facial indicia 10708 which “appears” to be facing the sound source determined at 1020. Once the sound source ceases, the facial indicia may return to expression 1070A. Similarly, facial indicia 1080A is normally facing towards the sound source until a particular sound source is detected. Upon detection of the particular sound source, the towards facing facial indicia 1080A transitions to the away facing facial indicia 1080B which “appears” to be facing away from the sound source determined at 1020. Once the sound source ceases, the facial indicia may return to expression 1080A. In one aspect, the latter example of 1080A and 10808 may trigger on a detection of off-notes or inaccuracies in the detected sound, such as mistakes by instruments or singers, for instance. In another instance, indicia may be life-size images of performers who interact like the performers they represent.

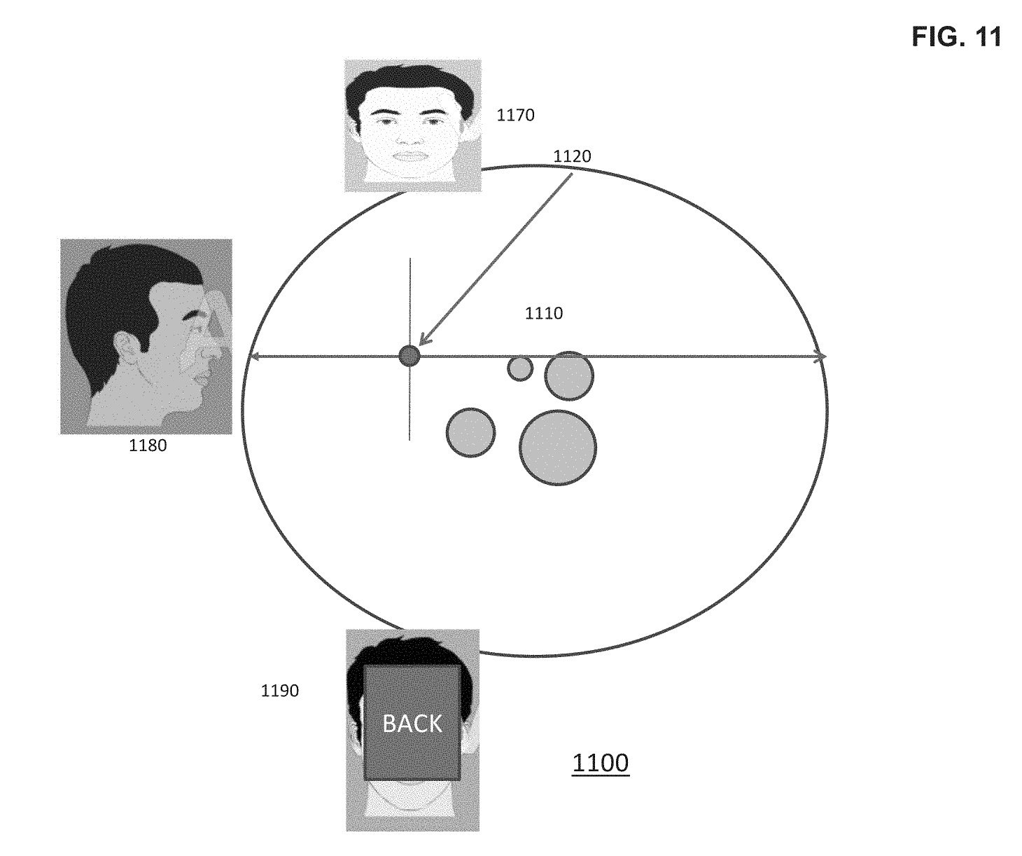

FIG. 11 depicts an example of multi-viewing interactive images for a plurality of indicia using the present invention in accordance with one or more embodiments. From FIG. 11, sound can emanate in the environment of 1100 from sound sources 1110. Determining a first reference sound location in relation to the sound sources has been performed by the present invention, determining such reference location to be at 1120. In the example of the present invention, the facial indicia 1170, 1180 and 1190 each include specific defined characteristics that also include movement to occur upon the detection of certain sound sources having predetermined sound characteristics. In general, for this example, two (1170, 1180) of the three indicia are set to “appear” to watch the reference location 1120 while one (1190) includes settings to not watch the reference location (1120).

From FIG. 11 and operatively, using the present invention, facial indicia 1070A is normally facing away from the sound source until a particular sound source is detected. Upon detection of the particular sound source, the away facing facial indicia 1070A transitions to the facing facial indicia 10708 which “appears” to be facing the sound source determined at 1020. Once the sound source ceases, the facial indicia may return to expression 1070A. Similarly, facial indicia 1080A is normally facing towards the sound source until a particular sound source is detected. Upon detection of the particular sound source, the towards facing facial indicia 1080A transitions to the away facing facial indicia 1080B which “appears” to be facing away from the sound source determined at 1020. Once the sound source ceases, the facial indicia may return to expression 1080A. In one aspect, the latter example of 1080A and 10808 may trigger on a detection of off-notes or inaccuracies in the detected sound, such as mistakes by instruments or singers, for instance.

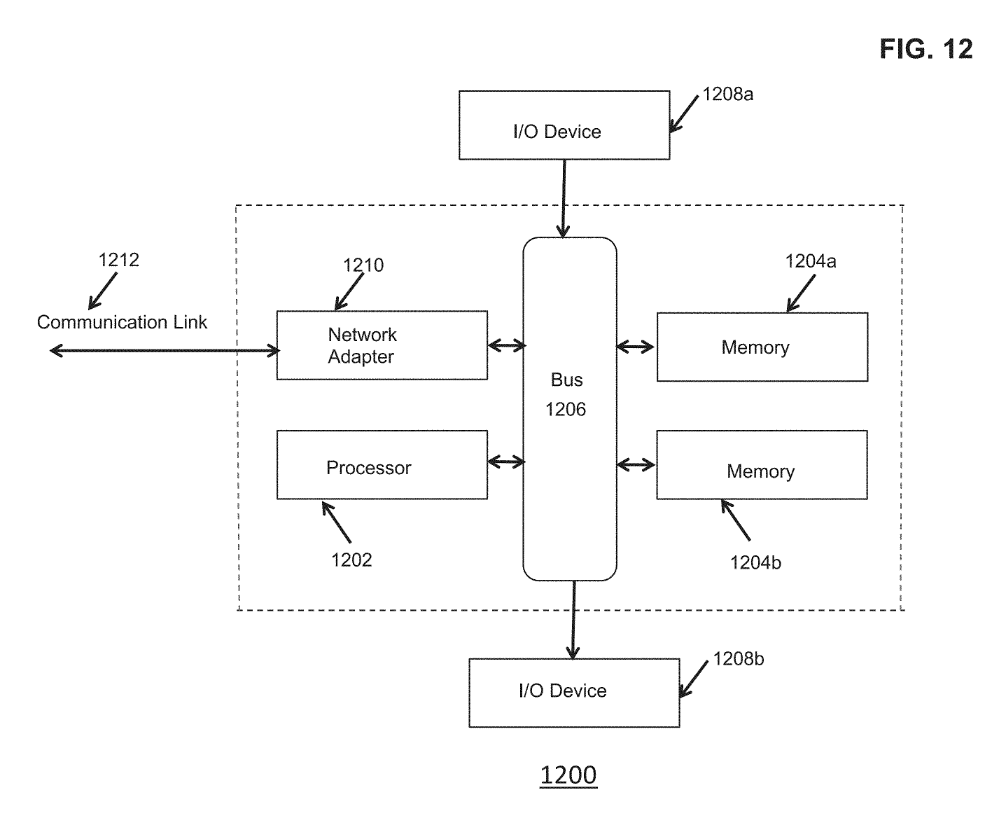

FIG. 12 illustrates a data processing system 1200 suitable for storing the computer program product and/or executing program code in accordance with one or more embodiments of the present invention. The data processing system 1200 includes a processor 1202 coupled to memory elements 1204a-b through a system bus 1206. In other embodiments, the data processing system 1200 may include more than one processor and each processor may be coupled directly or indirectly to one or more memory elements through a system bus.

Memory elements 1204a-b can include local memory employed during actual execution of the program code, bulk storage, and cache memories that provide temporary storage of at least some program code in order to reduce the number of times the code must be retrieved from bulk storage during execution. As shown, input/output or I/O devices 1208a-b (including, but not limited to, keyboards, displays, pointing devices, etc.) are coupled to the data processing system 1200. I/O devices 1208a-b may be coupled to the data processing system 1200 directly or indirectly through intervening I/O controllers (not shown).

Further, in FIG. 12, a network adapter 1210 is coupled to the data processing system 1202 to enable data processing system 1200 to become coupled to other data processing systems or remote printers or storage devices through communication link 1212. Communication link 1212 can be a private or public network. Modems, cable modems, and Ethernet cards are just a few of the currently available types of network adapters.

Additionally, in one or more preferred embodiments, the data processing system 1200 of FIG. 12 may further include logic and controllers suitable for executing program code in accordance with one or more embodiments of the present invention. For instance, the data processing system 1200 may include a plurality of processors at 1202, wherein each processor may pre-process, process or post-process data (such as but not limited to acoustic, image or tactile) that is received or transmitted in relation to the environment, sounds and effects in the environment and/or preference of a user of the present invention. The plurality of processors may be coupled to memory elements 1204a-b through a system bus 1206, in respect to their processing with the present invention. A plurality of input/output or I/O devices 1208a-b may be coupled to the data processing system 1200 directly, in association with a respective processor, or indirectly through intervening I/O controllers (not shown). Examples of such I/O devices may include but not be limited to microphones, microphone arrays, acoustic cameras, sound detection equipment, light detection equipment, etc.

In one or more preferred embodiments, software operative for the present invention may be an application, remote software or operable on a computer, smartphone, or other computer-based device. For instance, sound detected from a sound source such as iphone may be used with the present invention where software of the invention is arranged with a microphone array and acoustic cameras to detect sound sources from the iphone and display a visual image at the iphone in accordance with one or more embodiments of the present invention. It is envisioned that the present device may be used in most any environment and application including those involving but not limited to rock performance, video performance, theater, characterization and/or theatrics involving a live/dead performer, cartoon applications, interactive electronic and virtual forums, homeland security needs, security residential, etc.

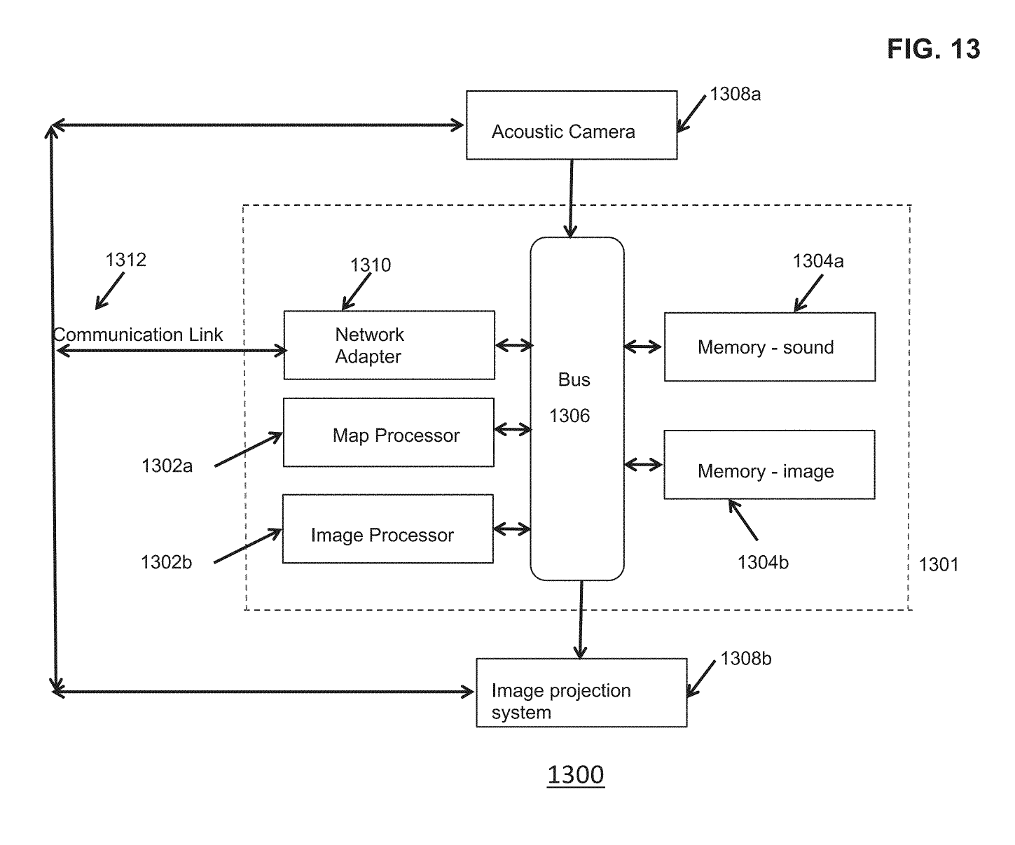

FIG. 13 illustrates an apparatus arrangement of the present invention including a data processing system 1300 suitable for storing the computer program product and/or executing program code in accordance with one or more embodiments of the present invention. The apparatus of 1300 includes an acoustic camera 1308a, for input of sound pressures and sound information associated with the environment, an image projection system 1308b, for output of processed image information to be displayed as a product of the processing of the apparatus, and a data processing sub-system 1301. The data processing sub-system 1301 includes a map processor 1302a (for processing received sound information from the acoustic camera input 1308a) and an image processor 1302b (for processing for output, image data in association with user defined characteristics), each coupled to memory elements 1304a-b through a system bus 1306. Memory element 1304a, for instance, can include user defined sound characteristics for identifying targets of interest with regard to sound in an environment. Similarly, memory element 1304b, for instance can include visual image data and user defined characteristics for application of visual image data in relation to identified sound information in the environment. It will be appreciated that additional memory elements and arrangements of memory are also envisioned by the present invention.

Further from FIG. 13, memory elements 1304a-b can include local memory employed during actual execution of the program code, bulk storage, and cache memories that provide temporary storage of at least some program code. Further memory elements or controllers (not shown) can additionally provide real-time, near real-time, and predetermined time instructions for determining steps when data capture, processing, and data display are performed by the present invention, essentially as a function of time.

Further, in FIG. 13, although the network adapter 1310 is diagrammatically coupled to the data processing system 1302 to enable data processing system 1301 to become coupled to other data processing systems, storage devices, projection systems, and similar, through communication link 1312, the specific arrangement of communication linkages is not limited by the present invention. Communication link 1312 can be a private or public network, wired or wireless, and direct or indirect in connectivity. I/O devices for this and other embodiments of the present invention can include, but not be limited to microphones, microphone arrays, acoustic cameras, sound detection equipment, light detection equipment, imagery projection systems, display systems, electronic media, etc.

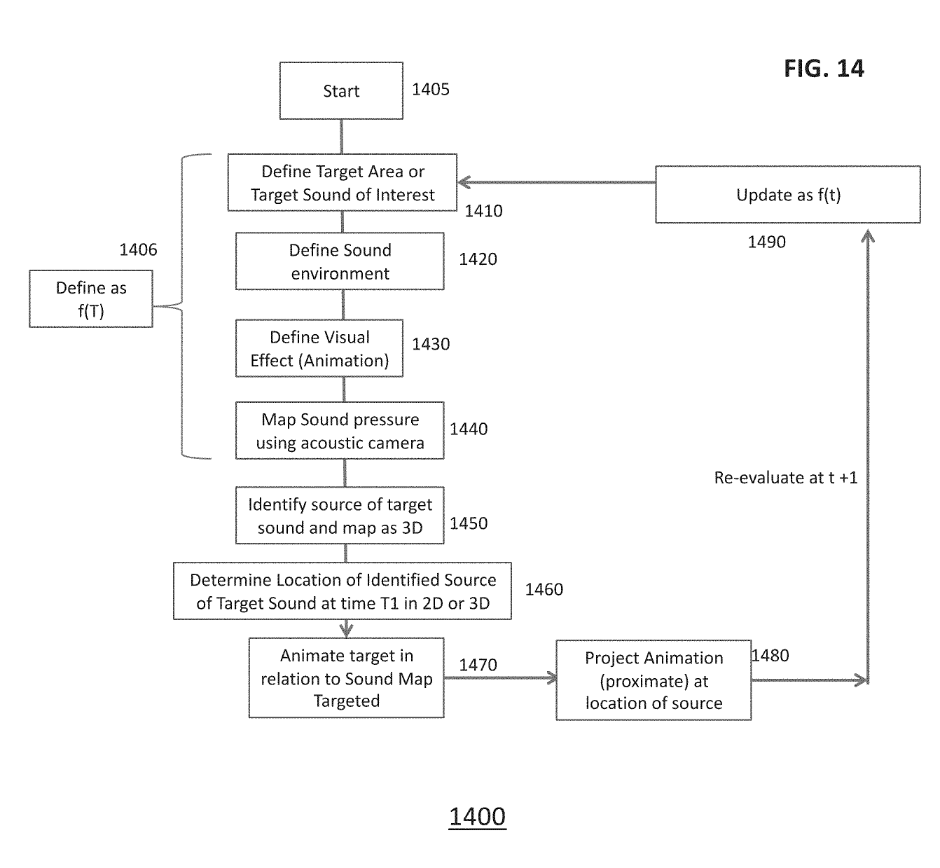

FIG. 14 sets forth a flowchart 1400 of the present invention in accordance with one or more embodiments where the definition of characteristic data also includes a dependence on one or more predetermined times using an input device of an acoustic camera and an output device of an image projection system. From FIG. 14, the process 1400 begins at 1405 for an initial time t1. At 1406, reference of the characteristic identification association as a function is time is set forth. From the process, the sound source or target area for the process is defined at 1410. The sound environment is defined at 1420 and at 1430, a visual effect (such as animation for instance) is identified for use by the present invention as a function of time. At 1440, using the sound target characteristics, each being a function of time, defining the sound and the defined sound sources to be targeted, sound sources are identified within the environment using the acoustic camera with the present invention. Preferably, the acoustic camera provides a mapping of the sound pressures detected in the environment and the data is input for processing by the present invention.

At 1450, positional locations of the identified sound sources are determined. In one or more preferred embodiments, the location may be a two axis coordinate or a three-dimensional coordinate. Similarly, additional processing by the present invention may provide conversion processing for two-dimensional location information to be converted to three-dimensional information. At 1460, the location of the identified source of target sound is determined. The process continues until 1470 where the visual effects are arranged in accordance with the user defined characteristics and are mapped in relation and proximity to the reference sound source based on determined and identified sound information and visual image data and preferences. At 1480, the visual image to be displayed is processed and arranged for display by the image projection system of the present invention. Using the present invention, the projection may display an image directly, indirectly, proximate to, distal from, at, towards or across a target location, whether two-dimensional or three-dimensional.

Accordingly, the process is then repeated at 1490 for t1+1 (for additional time periods). At 1490, since the characteristics are a function of time, new definitions may be set forth at 1410, or at other steps of the process if no changes occur with prior steps, and the process will continue with defined characteristics, acquired data, processed data, and data readied for output in accordance with the present invention, and also preferably, as a function of time for a time period following.

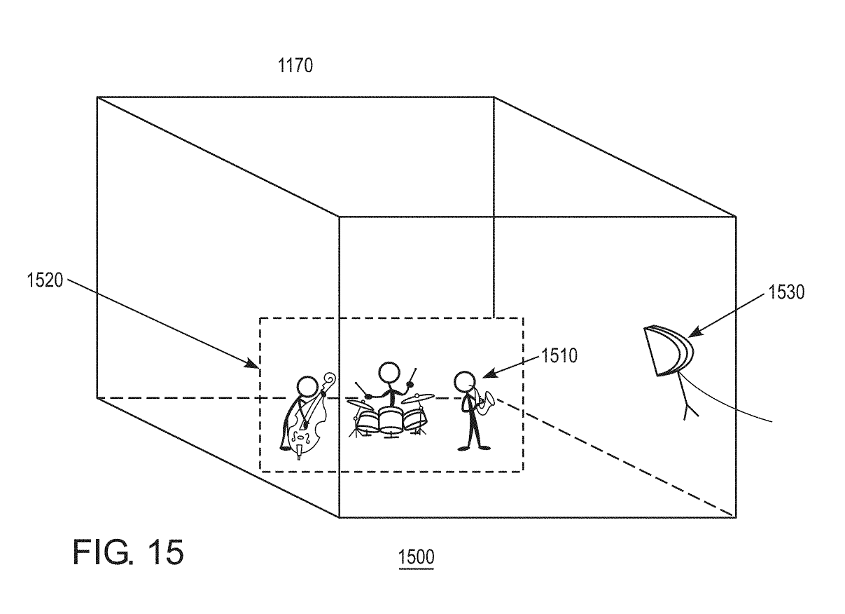

FIG. 15 illustrates an environment 1500 in which the present invention is in operation. From FIG. 15, the environment 1500 includes a sound source 1510, a target area or target reference frame 1520, and a sound detection and receiving device 1530. Preferably, in one or more embodiments, the sound source 1510 can be a group of musicians, a suite of sound generating equipment, stage performers, an animated movie, a single person, etc. Preferably, in one or more embodiments, the target reference frame or target area 1520 is defined to be the physical area in which detection of sound will occur where the target area may be, but is not so limited, a subset of the overall physical space available. A target area preferably will be defined by a user of the present invention or by default values for the present invention, where examples may include a 20′×20′×10′ area of the center stage where a live band is performing within a 100′×100′×50′ enclosure. Further, a receiving device is to be placed within the overall physical space and arranged to receive sound information from the sound source in the target area for optimal use by the present invention. In one or more preferred embodiments, the receiving device is an acoustic camera.

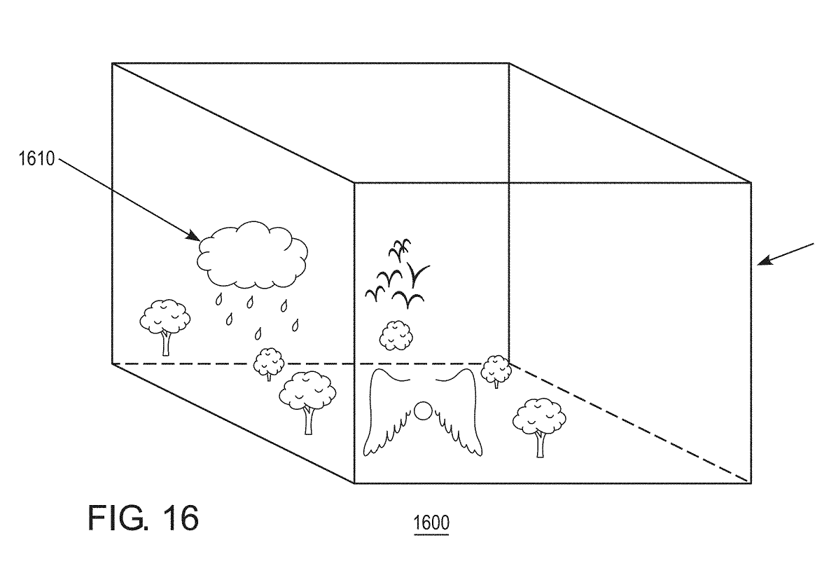

FIG. 16 illustrates an environment 1600 in which the present invention is in operation using sound animation in real-time. From FIG. 16, the environment 1600 includes a sound source, a target area or target reference frame, and a sound detection and receiving device (not shown). Animated imagery 1610 is depicted within the environment 1600. Animated imagery is the selected indicia to be displayed, visually, within the environment in accordance with one or more user-defined characteristics of a preferred visual effect. The selected animated imagery is arranged to be processed in real time so the imagery is projected proximate to and towards the target area in relation to detected sound information. Preferably, the animated imagery is responsive to the detected sound information (such as sound pressure, frequency, pitch, decibel, etc.) such that the animated imagery interacts with the sound pressure. For instance, where detected sound pressures increase and decrease to reflect an increasing and then decreasing loudness of sound, images of animated flowers, clouds, angels wings and the like can increase and decrease in size, visual transparency, motion, and color intensity and/or lighting effect, for example. It will be appreciated that using the present invention there are many variations available and that the present invention is not so limited to the listings above.

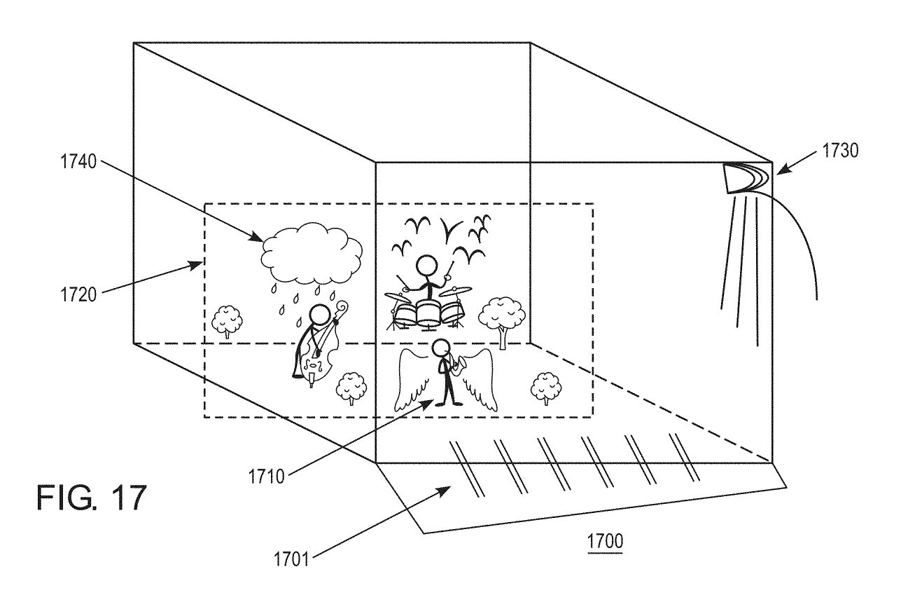

FIG. 17 illustrates an environment 1700 in which the present invention is in operation and projecting holographic animated imagery with live performers at a concert event. From FIG. 17, the environment 1700 includes a sound source 1710, a target area or target reference frame 1720, a sound detection and receiving device 1730, and a projection system (not shown). From FIG. 17, an audience is depicted at 1701. Preferably, in one embodiment, the sound source 1710 is a performing group of musicians, the target reference frame 1720 is defined proximate to the center stage, the receiving device 1730 is an acoustic camera, and the projection system provides for a three-dimension holographic display capability from a defined visual image in relation to predetermined characteristics.

From FIG. 17, the visual animation 1740 are projected by the projection system onto the stage of the environment 1700 proximate to the target area 1720 in relation to the sound information detected by the acoustic camera. Preferably, as a function of time, images displayed are updated in relation to detected and processed sound information by the present invention. Alternatively, images are displayed based upon a predetermined set of images, motion, visualization, etc., for a period of time.

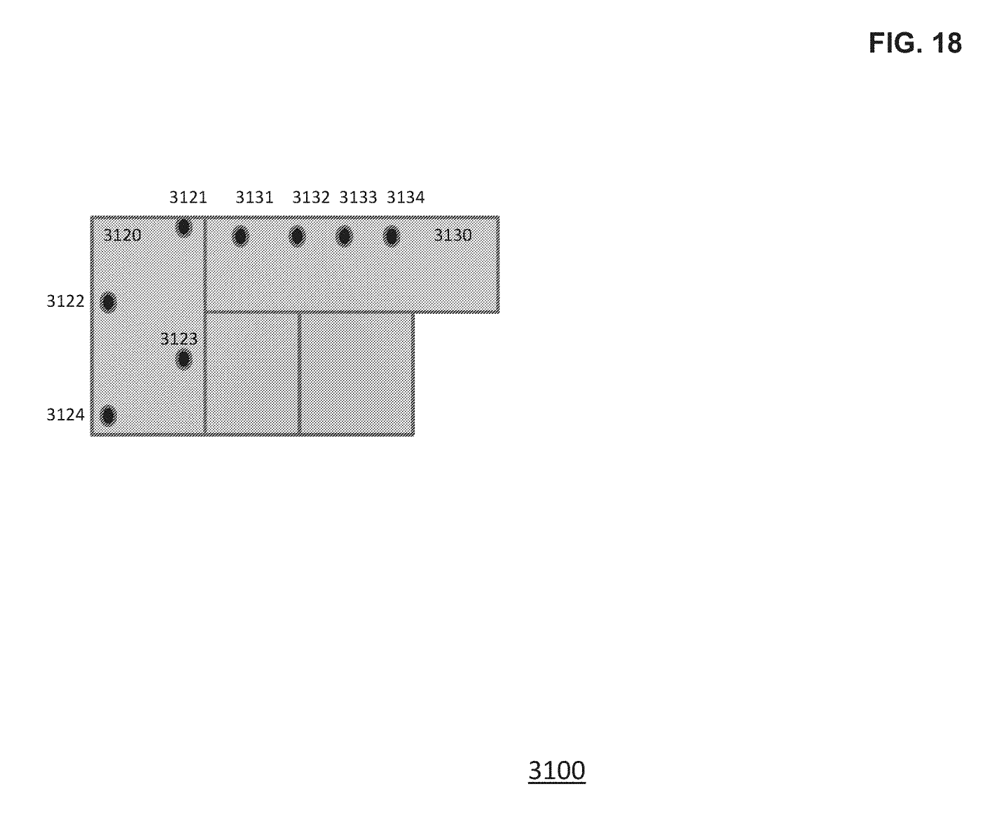

FIG. 18 presents a typical arrangement 1800 of a predetermined area 1810, such as a room in a residence. The room's physical dimensions may be determined from actual measurement or, more preferably, from an architectural rendering or blueprint in which the room is being or has been built to. Often, where a predetermined area's configuration has some complexity associated with it, a blueprint is preferred as a blueprint typically will also include details of construction, materials, other infrastructural systems (i.e., electrical, water, etc.), and other aspects which may affect sound quality within a predetermined area.

In one or more embodiments of the present invention, a determination is made from the blueprints as to where sound detection, monitoring, and/or emanation is sought. For instance, from FIG. 18, sound is desired to be monitored in the room identified at 1820 since this is identified as an infant's room. Similarly, from FIG. 18, sound is also desired to be a focal point at 1830, the living room, where it is desired to have an optimal quality of sound from the entertainment system. At 1820 and 1830, it is also desired to recognize that there will be human voices in these rooms as well as electronic sounds and to be able to differentiate between the two types.

Microphones are placed in each room that is desired to have sound detection, monitoring and/or emanation associated with it. It will be readily recognized that it may be advantageous to place one or more microphones in each room identified on a blueprint, depending on the specific need or situation. The placement of the microphones are then determined where each microphone's 2-D and 3-D coordinates are actually determined by physically measurement or virtually determined via one or more associated processors detection of sound waves transmitted for receipt by the microphones, in relation to each respective microphone. These determined locations of each microphone are directly associated with the blueprints such that each microphone has a set of blueprint coordinates associated with it.

From FIG. 18, a microphone array is placed at 1821-1824 in room 1820, and at 1831-1834 for room 1830, though a system and method in accordance with the present invention is neither so limited to nor dependent upon this exemplary depiction. Each of the placed microphones has a blueprint coordinate (X,Y,Z) associated with it and placed into a database associated with therewith.

From FIG. 18, in operation, a system and method in accordance with the present invention in one or more embodiments will typically utilize one or array of microphones in a predetermined location until there is a determination of a sound being detected or that there is a need to utilize a plurality of microphones. For instance, once a system and method in accordance with the present invention is operational, in room 1820, it may be determined that only microphone 1821 is active and on, while microphones 1822-1824 remain passive. However, upon the occurrence of detecting a sound, such as a non-human generated sound, the a system and method in accordance with the present invention may immediately activate microphones 1822-1824 such that they are active, may determine where the detected sound is located by one or more microphones, and may transmit the determined information to a receiving source.

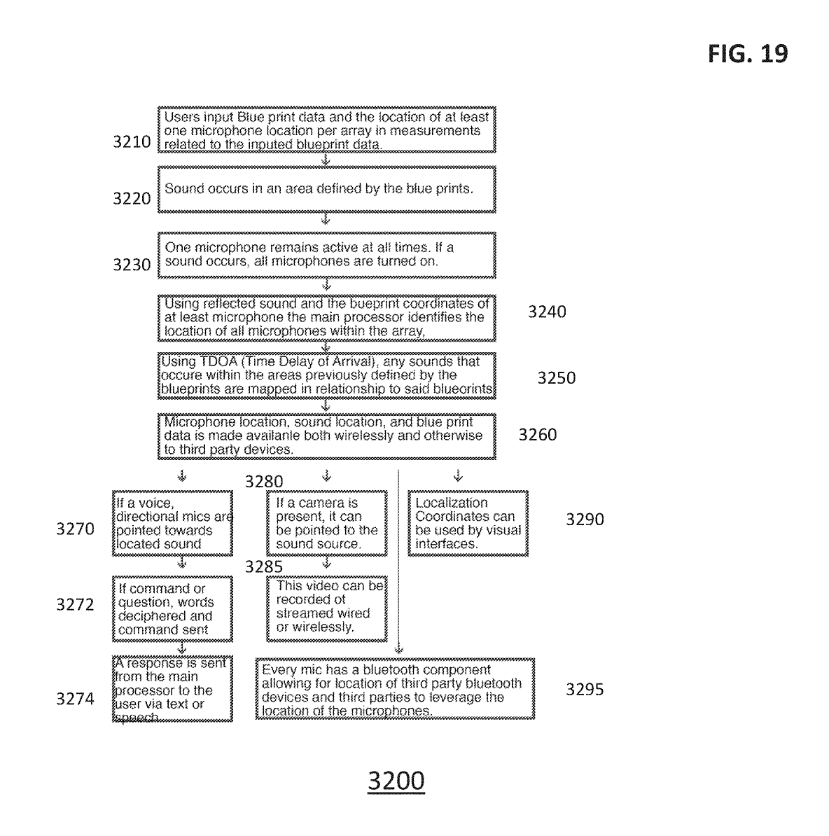

FIG. 19 sets forth a flowchart 1900 for the operation of a system and method in accordance with the present invention in accordance with one or more embodiments of the present invention.

From FIG. 19, the blueprint data of one or more predetermined locations along with the location data of at least one microphone, associated with the blueprint data, is provided at 1910. Preferably, the data associating the blueprint dimensions and the microphone location is stored in a database that is accessible by a system and method in accordance with the present invention. At 1920, a system and method in accordance with the present invention provides for detecting one or more sounds by one or more active microphones in a predetermined location. At 1930, upon the detection of a sound by an active microphone, if there are passive or non-active microphones also in the predetermined area, those passive or non-active microphones are also all turned on. Preferably, a system and method in accordance with the present invention may activate passive or non-active detection devices (microphones, camera, actuators, etc.) via a communication command which may be direct, indirect or remote, and may include a central server, a central processing unit (CPU), a computer, or other device enabling the transmission of a data signal to the passive or non-active device to turn on. Operationally, by having a single active microphones, power consumption and resource demands may be reduced via a system and method in accordance with the present invention.

At 1940, a system and method in accordance with the present invention then determines the location of all microphones within the array in the predetermined location using reflected sound determination techniques and the blueprint coordinates of at least one microphone in the predetermined area. Preferably, using reflected sound to measure the difference in time between the sound detected and reflected sound at each active microphone provides for the processing by a system and method in accordance with the present invention to determine the X, Y and Z coordinates of the microphones in a predetermined location. Preferably, a system and method in accordance with the present invention determines the location of all microphones at 1940 using the data previously stored from the blueprint and microphone locations as well as via reflected sound techniques; operationally this approach is advantageous as often only a single microphone's location may be precisely known or microphones (and other detection devices) may be moved from time to time for convenience.

At 1950, a system and method in accordance with the present invention maps one or more detected sounds in relation to the blueprint data for the predetermined location, using time delay of arrival (TDOA) techniques. At 1960, a system and method in accordance with the present invention provides information determined to a receiving source through a communication mechanism such as a wireless communication system or via a wired system. A system and method in accordance with the present invention is not limited to a particular manner of communicating the determined information to a receiving source.

At 1960, a system and method in accordance with the present invention has already determined what sound and type of sound has been determined (i.e., human, electronically-generated, etc.). Preferably the determination of the type of sound, as human or non-human, is determined by a system and method in accordance with the present invention comparing sound characteristics to the sound(s) detected by the one or microphones in which a determination of the sound being electronically-generated or not electronically-generated can be readily determined.

At 1970, where a voice sound has been detected, a system and method in accordance with the present invention arranges directional microphones which may be present in the predetermined location to be focused towards the detected sound. At 1972, a system and method in accordance with the present invention further determines, and may additional detect additional sounds, whether the detected sound is a command or is associated with the form of question, based on characteristics of the detected sound. For instance, a command may include, but not be limited to, words such as ON, OFF, OPEN, CLOSE, etc., and may be in any language. The commands, general or specific, may be part of a database which is readily accessible by a system and method in accordance with the present invention. Similarly, vocal patterns may be part of a database accessible by a system and method in accordance with the present invention in which voice sounds detected may be determined by a system and method in accordance with the present invention to form a question in which a response is being sought. A system and method in accordance with the present invention, in one or more preferred embodiments, may also include the capability to directly or indirectly provide an answer to the question in the form of an action, a text, a provision of a webpage or link, an electronically-generated response, or similar, at 1974; additionally, a system and method in accordance with the present invention may be able to refer the question to a secondary source, such as a smartphone having a voice-activated operating system, so the secondary source can be responsive to the question.

In a preferred embodiment, a system and method in accordance with the present invention includes cameras and actuation devices (locks, motors, on/off switches, etc.) which are also present in the predetermined location and each have a blueprint coordinate set associated with them. At 1980, after the detection of a sound is identified, an actuation device can be initiated to be actuated in response to the sound detected, such as turning a camera towards the sound source and activating the camera to provide, record, transmit, and otherwise provide imagery at 1982, wirelessly or wired.

At 1990, following the mapping of the information detected by a system and method in accordance with the present invention, the localization coordinates can be utilized by visual interfaces. For instance in one or more embodiments, once a sound is detected and the information is mapped, a mapping of a specific room and the location of the detection devices (microphones, cameras, etc.) may be sent to a user on a smartphone or via a URL link for access, where a user can view the activating and make appropriate decisions based on the information received.

At 1995, in one or more preferred embodiments, the detection device may include send, receive, transceiver capabilities. These capabilities may include but not be limited to Bluetooth for instance, where one or more detection devices in the predetermined location may further detect other connectable devices such that these other connectable devices may be connected to a system and method in accordance with the present invention and their features, characteristics and data gathering capabilities may also be used and/or integrated into a system and method in accordance with the present invention to further assist in sound detection, sound identification, sound localization, sound management, communications and dissemination.

A system and method in accordance with the present invention is also suited for rescue and emergency situations involving the safety of human life. For instance, an injured person in a predetermined location may call out within a specific room. The injured person's calling out is detected as human voice by a system and method in accordance with the present invention. In response to the call out by the injured person, the system may then communicate with the appropriate receiving source (user, emergency contact, police, computer, etc.) to communicate the information and/or the mapping of the information determined. In response, the receiving source can then act upon the information received.

Similarly, upon the occurrence of a fire, for instance, responding emergency personnel may receive a mapping of information in which coordinate sets of persons remaining in the building are identified and associated with their specific location in the residence or building. Additionally, whether a detected person is upright or in a downward location may also be determined as the three dimensional coordinate information is available for each person. Such information may assist emergency personnel is prioritizing a plan of action in response.

A system and method in accordance with the present invention provides processing, via one or more processors, to detect and determine one or more sounds from one or detection devices in communication with the one or more processors. The processing, in one or more preferred embodiments also provides for noise cancellation techniques and the cancelling of reflected sounds and white noise that are not a target of detection. The one or more processors may also be in communication with one or more connectable devices as well and is envisioned to be integrated with smart homes, intelligent systems and the like.

It will be appreciated that a system and method in accordance with the present invention may be integrated and adapted to work with a method for defining a reference sound position and producing an indicia proximate thereto in relation to one or more sound characteristics at a predetermined location, such as that disclosed in the related U.S. application Ser. No. 13/782,402, entitled “System and Method for Mapping and Displaying Audio Source Locations”. Preferably, the combined method includes: defining at least one sound characteristic to be detected; detecting at least one target sound in relation to the at least one sound characteristic; and determining the referenced sound position in relation to the detected target sound, associating the detected sound with the predetermined location's dimensional details and displaying the detected one or more sounds in relation to the predetermined location's dimensions.

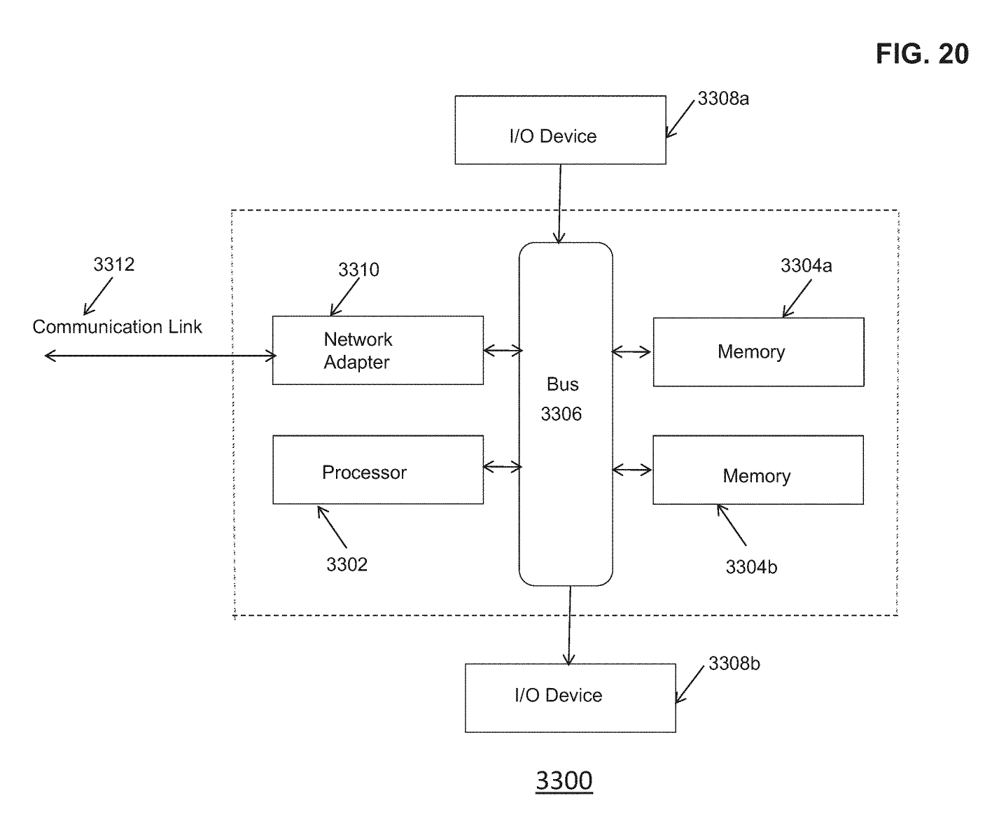

FIG. 20 illustrates a data processing system 2000 suitable for storing the computer program product and/or executing program code in accordance with one or more embodiments of the present invention. The data processing system 2000 includes a processor 2002 coupled to memory elements 2004a-b through a system bus 2006. In other embodiments, the data processing system 2000 may include more than one processor and each processor may be coupled directly or indirectly to one or more memory elements through a system bus.

Memory elements 2004a-b can include local memory employed during actual execution of the program code, bulk storage, and cache memories that provide temporary storage of at least some program code in order to reduce the number of times the code must be retrieved from bulk storage during execution. As shown, input/output or I/O devices 2008a-b (including, but not limited to, keyboards, displays, pointing devices, etc.) are coupled to the data processing system 2000. I/O devices 2008a-b may be coupled to the data processing system 2000 directly or indirectly through intervening I/O controllers (not shown).

Further, in FIG. 20, a network adapter 2010 is coupled to the data processing system 2002 to enable data processing system 2000 to become coupled to other data processing systems or remote printers or storage devices through communication link 2012. Communication link 2012 can be a private or public network. Modems, cable modems, and Ethernet cards are just a few of the currently available types of network adapters.

Additionally, in one or more preferred embodiments, the data processing system 2000 of FIG. 20 may further include logic and controllers suitable for executing program code in accordance with one or more embodiments of the present invention.

For instance, the data processing system 2000 may include a plurality of processors at 2002, wherein each processor may pre-process, process or post-process data (such as but not limited to detection device information, data and sensor data) that is received or transmitted in relation to the detection devices, the connectable devices and other data gathering devices in relation to the predetermined location and association with sound detection of a system and method in accordance with the present invention.

The plurality of processors may be coupled to memory elements 2004a-b through a system bus 2006, in respect to their processing with a system and method in accordance with the present invention. A plurality of input/output or I/O devices 2008a-b may be coupled to the data processing system 2000 directly, in association with a respective processor, or indirectly through intervening I/O controllers (not shown). Examples of such I/O devices may include but not be limited to microphones, microphone arrays, acoustic cameras, sound detection equipment, light detection equipment, actuation devices, smartphones, sensor-based devices, etc.

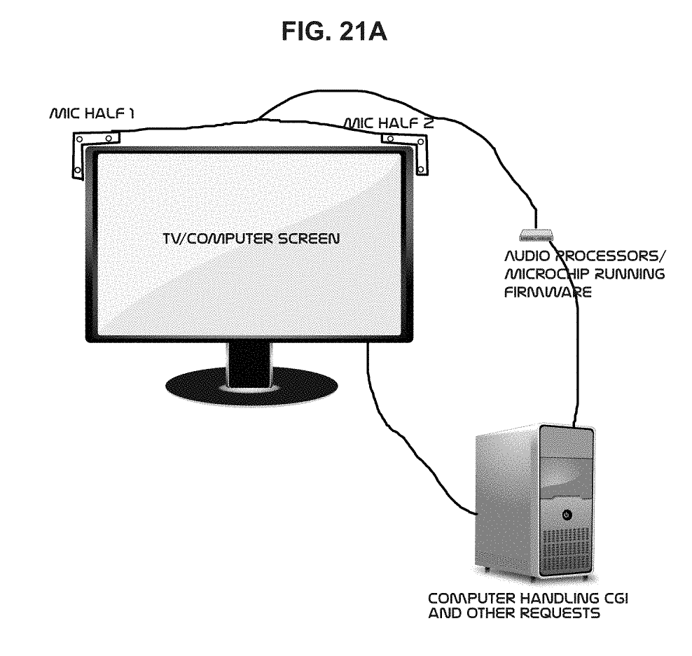

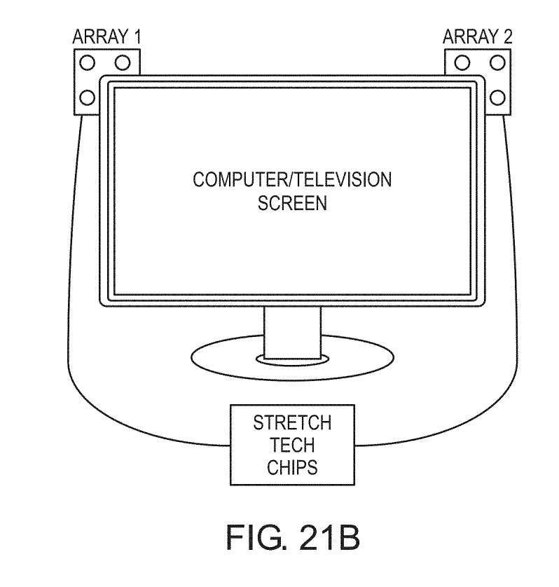

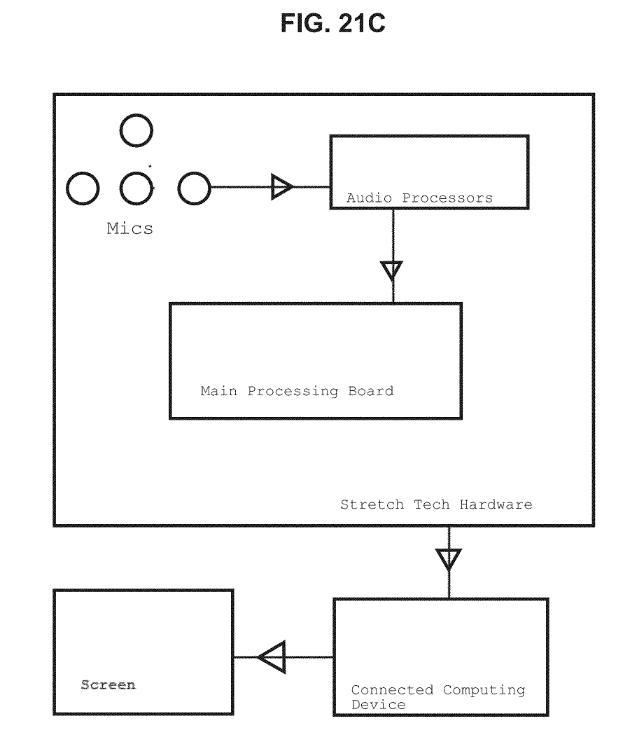

FIG. 21A illustrates another embodiment of a data processing system suitable for storing the computer program product and/or executing program code in accordance with one or more embodiments of the present invention. As clearly understood by those skilled in the art, components shown in FIG. 20 also appear FIG. 21A.

FIG. 21B illustrates yet another embodiment of a data processing system suitable for storing the computer program product and/or executing program code in accordance with one or more embodiments of the present invention. As clearly understood by those skilled in the art, components shown in FIG. 20 also appear FIG. 21B.

FIG. 21C illustrates still another embodiment of a data processing system suitable for storing the computer program product and/or executing program code in accordance with one or more embodiments of the present invention. As clearly understood by those skilled in the art, components shown in FIG. 20 also appear FIG. 210.

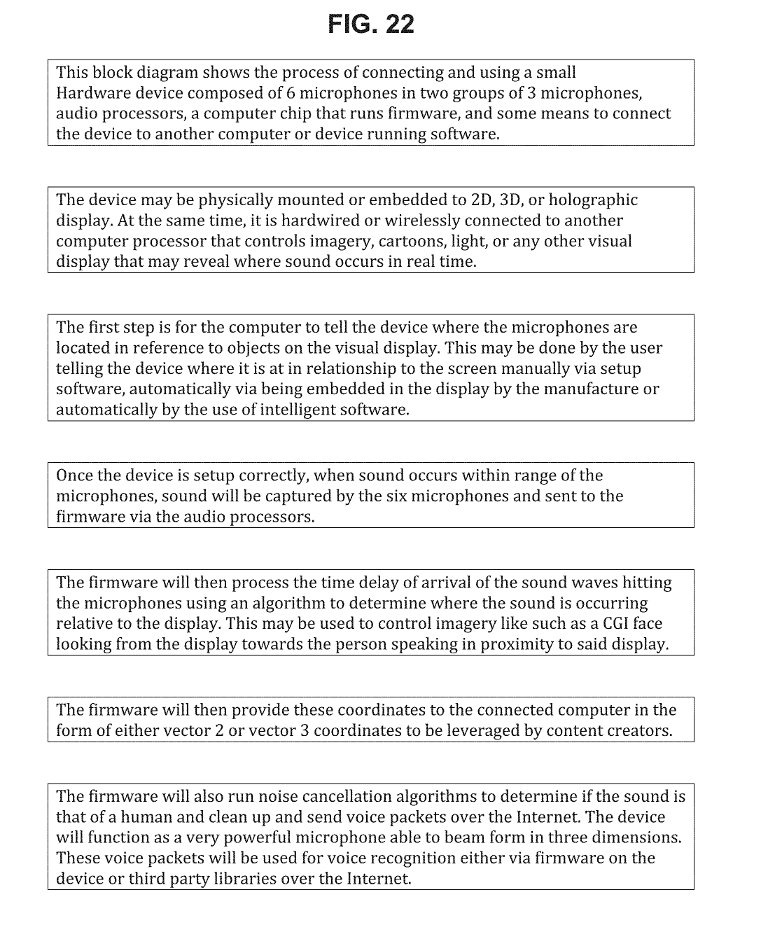

FIG. 22 sets forth a flowchart 2200 for the operation of a system and method in accordance with the another embodiment of claimed invention.

As shown in block 2210, flowchart 2300 illustrates a process according to embodiments herein of connecting and using a small hardware device (such ash the device shown in FIGS. 21A, 21B and 21C) composed of 6 microphones in two groups of 3 microphones, audio processors, a computer chip that runs firmware, and some means to connect the device to another computer or device running software.

According to block 2220, such a device may be physically mounted or embedded to 2D, 3D, or holographic display. At the same time, it is hardwired or wirelessly connected to another computer processor that controls imagery, cartoons, light, or any other visual display that may reveal where sound occurs in real time.

According to block 2230, a computing device (as shown in FIGS. 21A, 21B and 21C) tells the device where the microphones are located in reference to objects on the visual display. This may be done by the user telling the device where it is at in relationship to the screen manually via setup software, automatically via being embedded in the display by the manufacture or automatically by the use of intelligent software.

According to block 2240, once the device is setup correctly, when sound occurs within range of the microphones, sound will be captured by the six microphones and sent to the firmware via the audio processors.

According to block 2250, the firmware will then process the time delay of arrival of the sound waves hitting the microphones using an algorithm to determine where the sound is occurring relative to the display. This may be used to control imagery like such as a CGI face looking from the display towards the person speaking in proximity to said display.

According to block 2260, the firmware will then provide these coordinates to the connected computer in the form of either vector 2 or vector 3 coordinates to be leveraged by content creators.

According to block 2270, the firmware will also run noise cancellation algorithms to determine if the sound is that of a human and clean up and send voice packets over the Internet. The device will function as a very powerful microphone able to beam form in three dimensions. These voice packets will be used for voice recognition either via firmware on the device or third party libraries over the Internet.

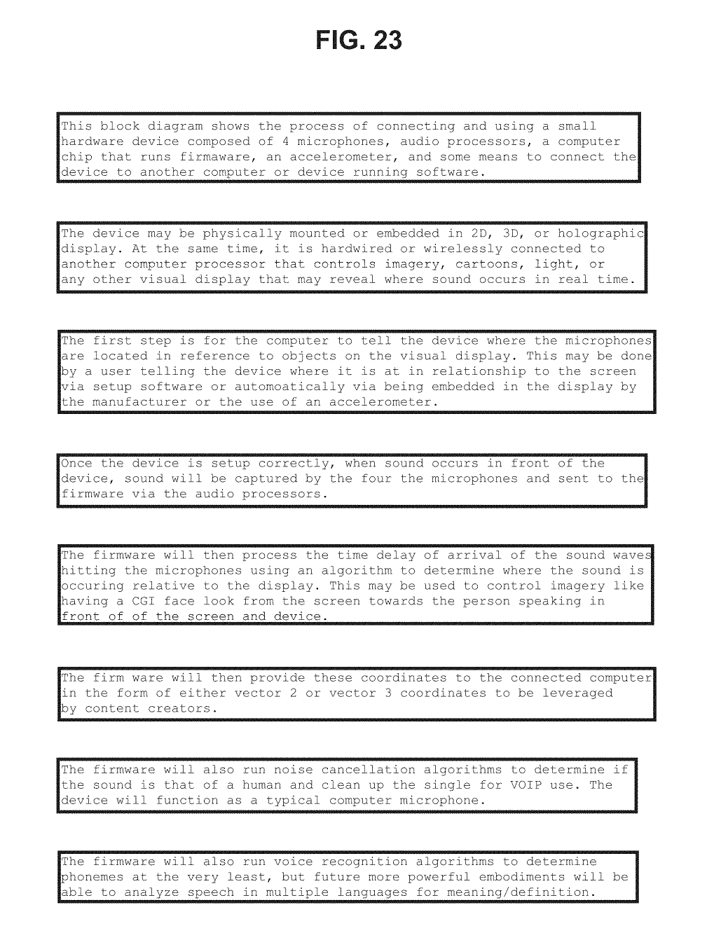

FIG. 23 sets forth a flowchart 2300 for the operation of a system and method in accordance with the another embodiment of claimed invention.

As shown in block 2310, flowchart 2300 illustrates a process according to embodiments herein of connecting and using a small hardware device (such ash the device shown in FIGS. 21A, 21B and 21C) composed of 4 microphones, audio processors, a computer chip that runs firmware, an accelerometer, and some means to connect the device to another computer or device running software.

According to block 2320, such a device may be physically mounted or embedded in 2D, 3D, or holographic display. At the same time, it is hardwired or wirelessly connected to another computer processor that controls imagery, cartoons, light, or any other visual display that may reveal where sound occurs in real time

According to block 2330, a computing device (as shown in FIGS. 21A, 21B and 21C) tells the device where the microphones are located in reference to objects on the visual display. This may be done by a user telling the device where it is at in relationship to the screen via setup software or automatically via being embedded in the display by the manufacturer or the use of an accelerometer.

According to block 2340, once the device is setup correctly, when sound occurs in front of the device, sound will be captured by the four the microphones and sent to the firmware via the audio processors.

According to block 2350, the firmware will then process the time delay of arrival of the sound waves hitting the microphones using an algorithm to determine where the sound is occurring relative to the display. This may be used to control imagery like having a CGI face look from the screen towards the person speaking in front of of the screen and device.

According to block 2360, the firm ware will then provide these coordinates to the connected computer in the form of either vector 2 or vector 3 coordinates to be leveraged by content creators.

According to block 2370, the firmware will also run noise cancellation algorithms to determine if the sound is that of a human and clean up the single for VOIP use. The device will function as a typical computer microphone.

According to block 2380, the firmware will also run voice recognition algorithms to determine phonemes at the very least, but future more powerful embodiments will be able to analyze speech in multiple languages for meaning/definition.

In one or more preferred embodiments, software operative for a system and method in accordance with the present invention may be an application, remote software or operable on a computer, smartphone, or other computer-based device. For instance, sound detected from a sound source such as a detection device (e.g., microphone array) may be used with a system and method in accordance with the present invention where software of the invention is arranged to detect sound sources from the detection devices, determine the type of sound detected, activate other detection devices, determine the detected sound or sounds location in relation to the dimensional data of the predetermined location, and provide the processed determinations as sound localization information that is available as text, hyperlink, web-based, three-dimensional or two-dimensional imagery, etc. A system and method in accordance with the present invention is capable of providing the visual image, including the mapping of the sound localization details, to a remote device or via a linked display, in accordance with one or more embodiments of the present invention. It is envisioned that the present device may be used in most any environment and application including those involving but not limited to entertainment, residential use, commercial use, emergency and governmental applications, interactive electronic and virtual forums, homeland security needs, etc.

In a further arrangement, an acoustic camera and video cameras may be used as additional detection devices or as connectable devices.

The system, program product and method provides for improved sound localization that provides for the specifics of a predetermined location's physical layout, a listener's static or dynamic location, and also for differentiation as between electronically-generated sound and human sound. A system and method in accordance with the present invention further provides for identifying one or more person's presence in a predetermined area using voice recognition technology.

In the described embodiments, the system and method may include any circuit, software, process and/or method, including an improvement to an existing software program, for instance.

Although the present invention has been described in accordance with the embodiments shown, one of ordinary skill in the art will readily recognize that there could be variations to the embodiments and those variations would be within the spirit and scope of the present invention, such as the inclusion of circuits, electronic devices, control systems, and other electronic and processing equipment. Accordingly, many modifications may be made by one of ordinary skill in the art without departing from the spirit and scope of the appended claims. Many other embodiments of the present invention are also envisioned.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

What is claimed is:

1. A method for defining a reference sound position and producing an animated indicia responsive to one or more sound characteristics, comprising:
generating the animated indicia responsive to sound;
defining at least one sound characteristic to be detected;
detecting at least one target sound in a three dimensional physical space in relation to the at least one sound characteristic;
determining the referenced sound position in relation to the detected target sound in the three dimensional physical space,
wherein the animated indicia responds proximate to the determined referenced sound position, and
wherein orientation of the animated indicia changes in relation to orientation of the detected target sound in the three dimensional physical space.

2. The method of claim 1, wherein the sound characteristics are one or more of: frequency range, decibel level, pitch range, loudness range and directional location.

3. The method of claim 2, wherein the referenced sound position includes a two-dimensional position in relation to the predetermined location.

4. The method of claim 3, wherein the referenced sound position includes a three-dimensional position in relation to a predetermined location.

5. The method of claim 2, wherein the at least one target sound is detected using one or more of a soundwave detector, acoustic camera, or electronic control logic.

6. The method of claim 5, wherein the soundwave detector is one of a(n): microphone, electronic sound sensor, listening device, decibel trigger, speaker, and hydrophone.

7. The method of claim 5, wherein the animated indicia is one or more of a: two dimensional image, visual image, cartoon, character representation, video, anime, light beam, animation, and combinations thereof, for display in relation to the detected target sound.

8. The method of claim 7, wherein producing the animated indicia further comprises displaying the animated indicia in relation to the referenced sound position in accordance with one or more predetermined times.

9. The method of claim 8, wherein the animated indicia is responsive in a two-dimensional virtual space proximate to the determined referenced sound source location.

10. A method for determining a reference sound source location and producing an animated indicia responsive to the reference sound location, in relation to one or more targeted characteristics of one or more sound sources, comprising:
defining one or more target sound characteristics being one or more of frequency range, decibel level, pitch range, loudness range, directional location, and period of time;
defining one or more characteristics of the animated indicia as being one or more of visible, audible, and/or tactile;
detecting at least one target sound in a three dimensional physical space in relation to the one or more target sound characteristics in the sound environment;
determining the referenced sound source location in relation to the detected target sound in the three dimensional physical space; and,
assigning an animation to be performed by the animated indicia proximate to the determined referenced sound source location,
wherein orientation of the animated indicia changes in relation to orientation of the detected target sound in the three dimensional physical space.

11. The method of claim 10, wherein the referenced sound source location includes either a two-dimensional or a three-dimensional coordinate position in relation to the sound environment.

12. The method of claim 11, wherein the at least one target sound is detected using one or more of a soundwave detector or acoustic camera.

13. The method of claim 12, wherein the animated indicia comprises a visual image displayed in relation to the target sound and appears to be at least one of interactive in relation to the referenced sound source location and not interactive in relation to the referenced sound source location.

14. A computer program product stored on a non-transitory computer usable medium, wherein the computer usable medium causes a computer to control an execution of an application to perform a method for producing an animated indicia responsive to a first reference sound location in relation to one or more sound characteristics, comprising:
defining the one or more sound characteristics;
receiving the one or more sound characteristics detected by a sound detector;
detecting at least one target sound in a three dimensional physical space in relation to the received one or more sound characteristics;
determining the first reference sound location in relation to the detected at least one target sound in the three dimensional physical space; and
transmitting the determined first reference sound location and instructions to produce the animated indicia responsive to sound,
wherein the animated indicia responds proximate to the first reference sound location, and
wherein orientation of the animated indicia changes in relation to orientation of the detected target sound in the three dimensional physical space.

15. The program product of claim 14, wherein the received sound characteristics are one or more of: frequency range, decibel level, pitch range, loudness range, directional location, and period of time.

16. The program product of claim 15, wherein the first reference sound position includes either a two-dimensional position or a three-dimensional position in relation to a first reference axis.

17. The program product of claim 16, wherein the sound detector is an acoustic camera or electronic control logic.

18. The program product of claim 16, wherein the sound detector comprises a detection device operatively connected to the computer through a communication link operatively connected to a public network.

19. The program product of claim 16, wherein the animated indicia comprises one or more of a: two dimensional image, visual image, cartoon, character representation, video, anime, light beam, animation, and combinations thereof, for display in relation to the first reference sound location.

20. The program product of claim 19, wherein the animated indicia is responsively displayed in proximity to the first reference sound location by displaying an appearance of movement in relation to one or more detected interactive sounds.
